(19) United States
(12) Patent Application Publication
(10) Pub. No.: US 2019/0138303 A1
(43) Pub. Date: May 9, 2019

(54) APPARATUS AND METHOD FOR VECTOR HORIZONTAL LOGICAL INSTRUCTION

(71) Applicant: Intel Corporation, Santa Clara, CA (US)

(72) Inventors: Elmoustapha OULD-AHMED-VALL, Chandler, AZ (US); David GUILLEN FANDOS, Tarragona (ES); Jesus F. SANCHEZ, Barcelona (ES); Guillem SOLE, Barcelona (ES); Roger ESPASA, Barcelona (ES)

(21) Appl. No.: 16/110,298

(22) Filed: Aug. 23, 2018

Related U.S. Application Data
(63) Continuation of application No. 14/582,170, filed on Dec. 23, 2014, now abandoned.

(51) Int. Cl. G06F 9/30; G06F 9/34

(52) U.S. Cl. CPC G06F 9/30029; G06F 9/30167; G06F 9/30036; G06F 9/34

(57) ABSTRACT

An apparatus and method are described for performing vector horizontal logical instruction. For example, one embodiment of a processor comprises: fetch logic to fetch an instruction from memory, and execution logic to determine a value of a first set of one or more data elements from a first specified set of bits of an immediate operand, wherein positions of the first set of one or more data elements determined from the first specified set of bits of the immediate operand are based on a first set of one or more index values that have a most significant bit corresponding to a packed data element at a first set of one or more positions of a destination packed data operand and that have a least significant bit corresponding to a data element at a corresponding position of a first source packed data operand.

### FIELD OF THE INVENTION

Embodiments of the invention relate generally to the field of computer systems. More particularly, the embodiments of the invention relate to an apparatus and method for performing a vector horizontal logical instruction within a computer processor.

### BACKGROUND

Certain types of applications often require the same operation to be performed on a large number of data items (referred to as “data parallelism”). Single Instruction Multiple Data (SIMD) refers to a type of instruction that causes a processor to perform an operation on multiple data items. SIMD technology is especially suited to processors that can logically divide the bits in a register into a number of fixed-sized data elements, each of which represents a separate value. For example, the bits in a 256-bit register may be specified as a source operand to be operated on as four separate 64-bit packed data elements (quad-word (Q) size data elements), eight separate 32-bit packed data elements (double word (D) size data elements), sixteen separate 16-bit packed data elements (word (W) size data elements), or thirty-two separate 8-bit data elements (byte (B) size data elements). This type of data is referred to as “packed” data type or a “vector” data type, and operands of this data type are referred to as packed data operands or vector operands. In other words, a packed data item or vector refers to a sequence of packed data elements, and a packed data operand or a vector operand is a source or destination operand of a SIMD instruction (also known as a packed data instruction or a vector instruction).

The SIMD technology, such as that employed by the Intel® Core™ processors having an instruction set including x86, MMX™, Streaming SIMD Extensions (SSE), SSE2, SSE3, SSE4.1, and SSE4.2 instructions, has enabled a significant improvement in application performance. An additional set of SIMD extensions, referred to the Advanced Vector Extensions (AVX) (AVX1 and AVX2) and using the Vector Extensions (VEX) coding scheme, has been released (see, e.g., see Intel® 64 and IA-32 Architectures Software Developers Manual, October 2011; and see Intel® Advanced Vector Extensions Programming Reference, June 2011). These AVX extensions have been further proposed to be extended to support 512-bit registers (AVX-512) using the Extended Vector Extensions (EVEX) coding scheme.

A challenge exists in applying two or more binary functions to a series of bit vectors or Boolean matrices. An example of a set of binary functions operating on Boolean (bit) matrices is the inversion of arrays of invertible matrices (e.g. 64×64 bit matrices). Applying the functions directly to these data structures may be inefficient, as these structures are limited to having values of 0 or 1, and so are constrained in their output values. Thus, an increase in efficiency may be gained if such a set of binary functions were implemented in a way to reduce unnecessary calculations.

### BRIEF DESCRIPTION OF THE DRAWINGS

FIG. 1A is a block diagram illustrating both an exemplary in-order pipeline and an exemplary register renaming, out-of-order issue/execution pipeline according to embodiments of the invention;

FIG. 1B is a block diagram illustrating both an exemplary embodiment of an in-order architecture core and an exemplary register renaming, out-of-order issue/execution architecture core to be included in a processor according to embodiments of the invention;

FIG. 2 is a block diagram of a single core processor and a multicore processor with integrated memory controller and graphics according to embodiments of the invention;

FIG. 3 illustrates a block diagram of a system in accordance with one embodiment of the present invention;

FIG. 4 illustrates a block diagram of a second system in accordance with an embodiment of the present invention;

FIG. 5 illustrates a block diagram of a third system in accordance with an embodiment of the present invention;

FIG. 6 illustrates a block diagram of a system on a chip (SoC) in accordance with an embodiment of the present invention;

FIG. 7 illustrates a block diagram contrasting the use of a software instruction converter to convert binary instructions in a source instruction set to binary instructions in a target instruction set according to embodiments of the invention;

FIG. 8 is a block diagram illustrating a system 800 that is operable to perform an embodiment of a vector horizontal binary logical instruction;

FIG. 9A illustrates logic 900 for performing a vector horizontal binary logical operation in accordance with one embodiment of the invention;

FIG. 9B illustrates another aspect of logic 900 for performing a vector horizontal binary logical operation in accordance with one embodiment of the invention;

FIG. 9C illustrates two tables showing how DEST, SRC1, and SRC2 may be used as index positions for IMM_HI and IMM_LO according to an embodiment of the invention.

FIG. 10 is a flow diagram of a method 1000 for a system operable to perform an embodiment of a vector horizontal binary logical instruction;

FIG. 11 is pseudocode for logic operable to perform an embodiment of a vector horizontal binary logical instruction;

FIGS. 12A and 12B are block diagrams illustrating a generic vector friendly instruction format and instruction templates thereof according to embodiments of the invention;

FIGS. 13A-D are block diagrams illustrating an exemplary specific vector friendly instruction format according to embodiments of the invention;

FIG. 14 is a block diagram of a register architecture according to one embodiment of the invention; and

FIGS. 15A-B illustrate a block diagram of a more specific exemplary in-order core architecture.

### DETAILED DESCRIPTION

### Exemplary Processor Architectures

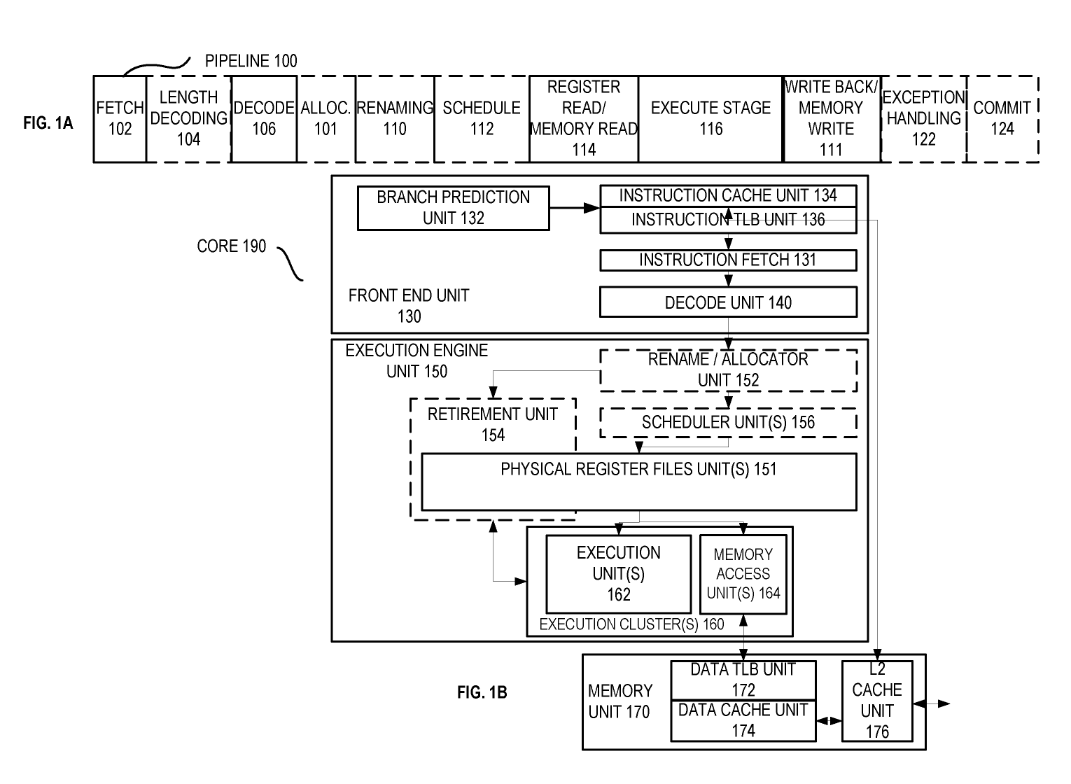

FIG. 1A is a block diagram illustrating both an exemplary in-order fetch, decode, retire pipeline and an exemplary register renaming, out-of-order issue/execution pipeline according to embodiments of the invention. FIG. 1B is a block diagram illustrating both an exemplary embodiment of an in-order fetch, decode, retire core and an exemplary register renaming, out-of-order issue/execution architecture core to be included in a processor according to embodiments of the invention. The solid lined boxes in FIGS. 1A-B illustrate the in-order portions of the pipeline and core, while the optional addition of the dashed lined boxes illustrates the register renaming, out-of-order issue/execution pipeline and core.

In FIG. 1A, a processor pipeline 100 includes a fetch stage 102, a length decode stage 104, a decode stage 106, an allocation stage 108, a renaming stage 110, a scheduling (also known as a dispatch or issue) stage 112, a register read/memory read stage 114, an execute stage 116, a write back/memory write stage 118, an exception handling stage 122, and a commit stage 124.

FIG. 1B shows processor core 190 including a front end unit 130 coupled to an execution engine unit 150, and both are coupled to a memory unit 170. The core 190 may be a reduced instruction set computing (RISC) core, a complex instruction set computing (CISC) core, a very long instruction word (VLIW) core, or a hybrid or alternative core type. As yet another option, the core 190 may be a special-purpose core, such as, for example, a network or communication core, compression engine, coprocessor core, general purpose computing graphics processing unit (GPGPU) core, graphics core, or the like.

The front end unit 130 includes a branch prediction unit 132 coupled to an instruction cache unit 134, which is coupled to an instruction translation lookaside buffer (TLB) 136, which is coupled to an instruction fetch unit 138, which is coupled to a decode unit 140. The decode unit 140 (or decoder) may decode instructions, and generate as an output one or more micro-operations, micro-code entry points, microinstructions, other instructions, or other control signals, which are decoded from, or which otherwise reflect, or are derived from, the original instructions. The decode unit 140 may be implemented using various different mechanisms. Examples of suitable mechanisms include, but are not limited to, look-up tables, hardware implementations, programmable logic arrays (PLAs), microcode read only memories (ROMs), etc. In one embodiment, the core 190 includes a microcode ROM or other medium that stores microcode for certain macroinstructions (e.g., in decode unit 140 or otherwise within the front end unit 130). The decode unit 140 is coupled to a rename/allocator unit 152 in the execution engine unit 150.

The execution engine unit 150 includes the rename/allocator unit 152 coupled to a retirement unit 154 and a set of one or more scheduler unit(s) 156. The scheduler unit(s) 156 represents any number of different schedulers, including reservations stations, central instruction window, etc. The scheduler unit(s) 156 is coupled to the physical register file(s) unit(s) 158. Each of the physical register file(s) units 158 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 158 comprises a vector registers unit, a write mask registers unit, and a scalar registers unit. These register units may provide architectural vector registers, vector mask registers, and general purpose registers. The physical register file(s) unit(s) 158 is overlapped by the retirement unit 154 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 154 and the physical register file(s) unit(s) 158 are coupled to the execution cluster(s) 160. The execution cluster(s) 160 includes a set of one or more execution units 162 and a set of one or more memory access units 164. The execution units 162 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 156, physical register file(s) unit(s) 158, and execution cluster(s) 160 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 164). It should also be understood that where separate pipelines are used, one or more of these pipelines may be out-of-order issue/execution and the rest in-order.

The set of memory access units 164 is coupled to the memory unit 170, which includes a data TLB unit 172 coupled to a data cache unit 174 coupled to a level 2 (L2) cache unit 176. In one exemplary embodiment, the memory access units 164 may include a load unit, a store address unit, and a store data unit, each of which is coupled to the data TLB unit 172 in the memory unit 170. The instruction cache unit 134 is further coupled to a level 2 (L2) cache unit 176 in the memory unit 170. The L2 cache unit 176 is coupled to one or more other levels of cache and eventually to a main memory.

By way of example, the exemplary register renaming, out-of-order issue/execution core architecture may implement the pipeline 100 as follows: 1) the instruction fetch 138 performs the fetch and length decoding stages 102 and 104; 2) the decode unit 140 performs the decode stage 106; 3) the rename/allocator unit 152 performs the allocation stage 108 and renaming stage 110; 4) the scheduler unit(s) 156 performs the schedule stage 112; 5) the physical register file(s) unit(s) 158 and the memory unit 170 perform the register read/memory read stage 114; the execution cluster 160 perform the execute stage 116; 6) the memory unit 170 and the physical register file(s) unit(s) 158 perform the write back/memory write stage 118; 7) various units may be involved in the exception handling stage 122; and 8) the retirement unit 154 and the physical register file(s) unit(s) 158 perform the commit stage 124.

The core 190 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 190 includes logic to support a packed data instruction set extension (e.g., AVX1, AVX2, and/or some form of the generic vector friendly instruction format (U=0 and/or U=1), described below), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 134/174 and a shared L2 cache unit 176, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

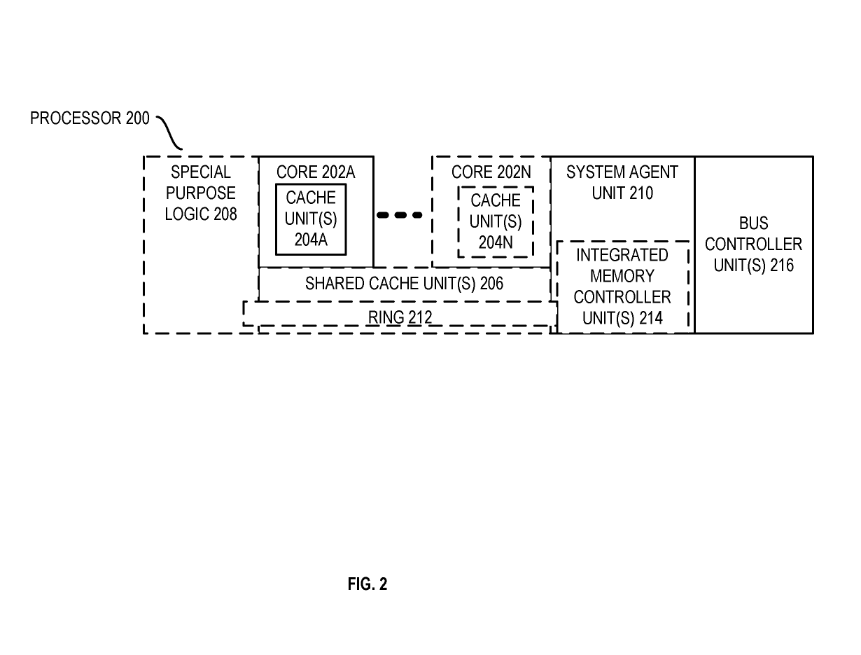

FIG. 2 is a block diagram of a processor 200 that may have more than one core, may have an integrated memory controller, and may have integrated graphics according to embodiments of the invention. The solid lined boxes in FIG. 2 illustrate a processor 200 with a single core 202A, a system agent 210, a set of one or more bus controller units 216, while the optional addition of the dashed lined boxes illustrates an alternative processor 200 with multiple cores 202A-N, a set of one or more integrated memory controller unit(s) 214 in the system agent unit 210, and special purpose logic 208.

Thus, different implementations of the processor 200 may include: 1) a CPU with the special purpose logic 208 being integrated graphics and/or scientific (throughput) logic (which may include one or more cores), and the cores 202A-N being one or more general purpose cores (e.g., general purpose in-order cores, general purpose out-of-order cores, a combination of the two); 2) a coprocessor with the cores 202A-N being a large number of special purpose cores intended primarily for graphics and/or scientific (throughput); and 3) a coprocessor with the cores 202A-N being a large number of general purpose in-order cores. Thus, the processor 200 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 200 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 206, and external memory (not shown) coupled to the set of integrated memory controller units 214. The set of shared cache units 206 may include one or more mid-level caches, such as level 2 (L2), level 3 (L3), level 4 (L4), or other levels of cache, a last level cache (LLC), and/or combinations thereof. While in one embodiment a ring based interconnect unit 212 interconnects the integrated graphics logic 208, the set of shared cache units 206, and the system agent unit 210/integrated memory controller unit(s) 214, alternative embodiments may use any number of well-known techniques for interconnecting such units. In one embodiment, coherency is maintained between one or more cache units 206 and cores 202-A-N.

In some embodiments, one or more of the cores 202A-N are capable of multi-threading. The system agent 210 includes those components coordinating and operating cores 202A-N. The system agent unit 210 may include for example a power control unit (PCU) and a display unit. The PCU may be or include logic and components needed for regulating the power state of the cores 202A-N and the integrated graphics logic 208. The display unit is for driving one or more externally connected displays.

The cores 202A-N may be homogenous or heterogeneous in terms of architecture instruction set; that is, two or more of the cores 202A-N may be capable of execution the same instruction set, while others may be capable of executing only a subset of that instruction set or a different instruction set. In one embodiment, the cores 202A-N are heterogeneous and include both the “small” cores and “big” cores described below.

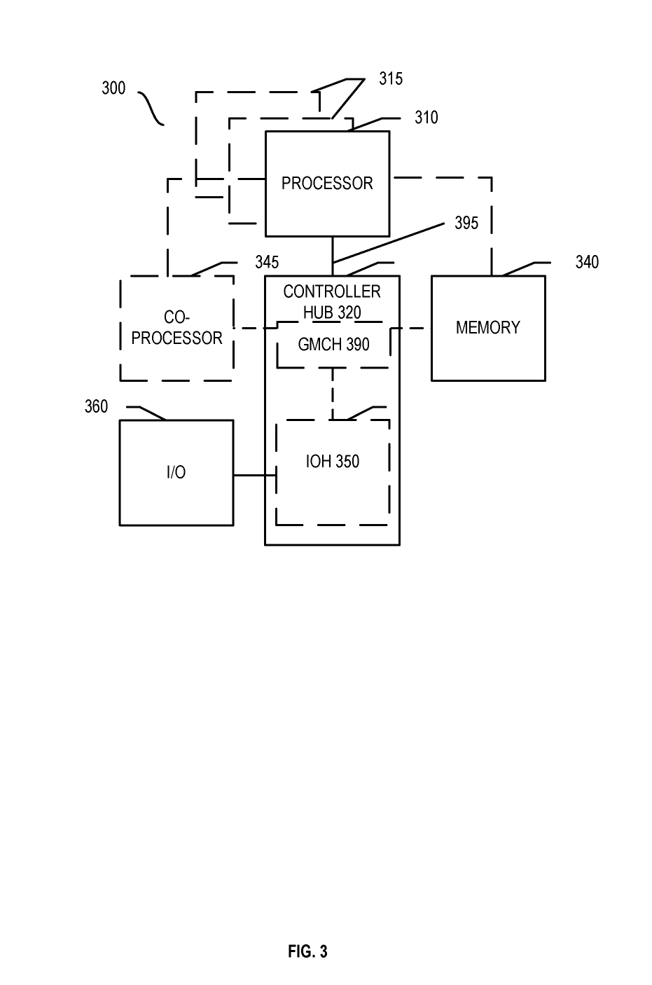

FIGS. 3-6 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 3, shown is a block diagram of a system 300 in accordance with one embodiment of the present invention. The system 300 may include one or more processors 310, 315, which are coupled to a controller hub 320. In one embodiment the controller hub 320 includes a graphics memory controller hub (GMCH) 390 and an Input/Output Hub (IOH) 350 (which may be on separate chips); the GMCH 390 includes memory and graphics controllers to which are coupled memory 340 and a coprocessor 345; the IOH 350 is couples input/output (I/O) devices 360 to the GMCH 390. Alternatively, one or both of the memory and graphics controllers are integrated within the processor (as described herein), the memory 340 and the coprocessor 345 are coupled directly to the processor 310, and the controller hub 320 in a single chip with the IOH 350.

The optional nature of additional processors 315 is denoted in FIG. 3 with broken lines. Each processor 310, 315 may include one or more of the processing cores described herein and may be some version of the processor 200.

The memory 340 may be, for example, dynamic random access memory (DRAM), phase change memory (PCM), or a combination of the two. For at least one embodiment, the controller hub 320 communicates with the processor(s) 310, 315 via a multi-drop bus, such as a frontside bus (FSB), point-to-point interface such as QuickPath Interconnect (QPI), or similar connection 395.

In one embodiment, the coprocessor 345 is a special-purpose processor, such as, for example, a high-throughput MIC processor, a network or communication processor, compression engine, graphics processor, GPGPU, embedded processor, or the like. In one embodiment, controller hub 320 may include an integrated graphics accelerator.

There can be a variety of differences between the physical resources 310, 315 in terms of a spectrum of metrics of merit including architectural, microarchitectural, thermal, power consumption characteristics, and the like.

In one embodiment, the processor 310 executes instructions that control data processing operations of a general type. Embedded within the instructions may be coprocessor instructions. The processor 310 recognizes these coprocessor instructions as being of a type that should be executed by the attached coprocessor 345. Accordingly, the processor 310 issues these coprocessor instructions (or control signals representing coprocessor instructions) on a coprocessor bus or other interconnect, to coprocessor 345. Coprocessor(s) 345 accept and execute the received coprocessor instructions.

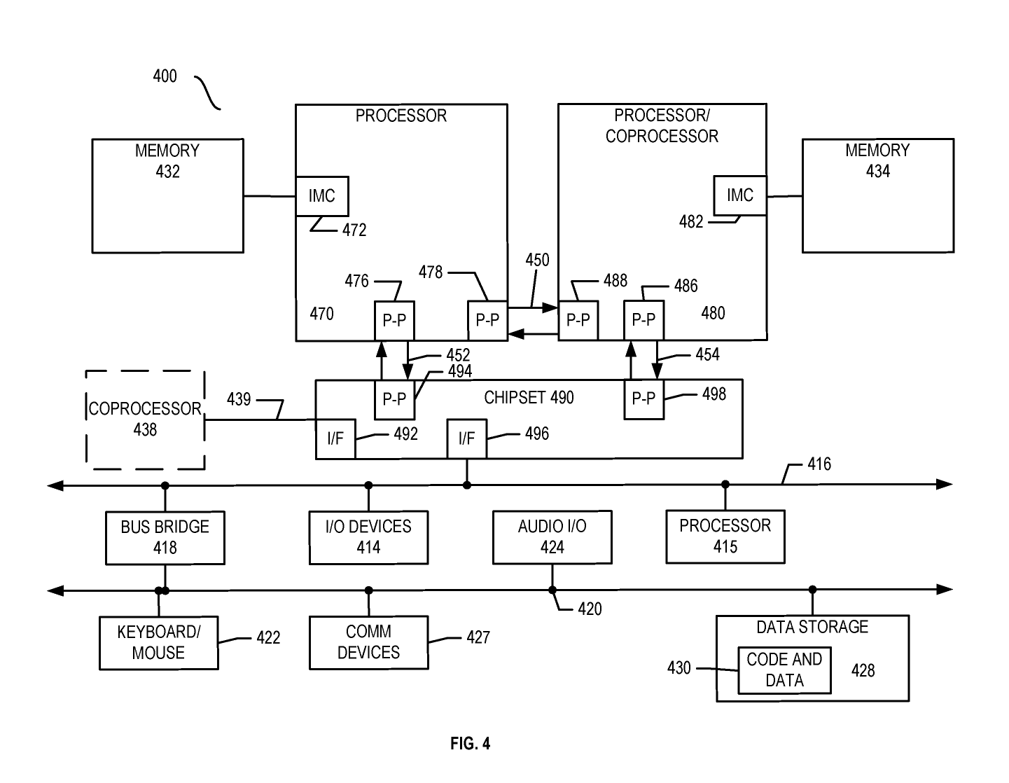

Referring now to FIG. 4, shown is a block diagram of a first more specific exemplary system 400 in accordance with an embodiment of the present invention. As shown in FIG. 4, multiprocessor system 400 is a point-to-point interconnect system, and includes a first processor 470 and a second processor 480 coupled via a point-to-point interconnect 450. Each of processors 470 and 480 may be some version of the processor 200. In one embodiment of the invention, processors 470 and 480 are respectively processors 310 and 315, while coprocessor 438 is coprocessor 345. In another embodiment, processors 470 and 480 are respectively processor 310 coprocessor 345.

Processors 470 and 480 are shown including integrated memory controller (IMC) units 472 and 482, respectively. Processor 470 also includes as part of its bus controller units point-to-point (P-P) interfaces 476 and 478; similarly, second processor 480 includes P-P interfaces 486 and 488. Processors 470, 480 may exchange information via a point-to-point (P-P) interface 450 using P-P interface circuits 478, 488. As shown in FIG. 4, IMCs 472 and 482 couple the processors to respective memories, namely a memory 432 and a memory 434, which may be portions of main memory locally attached to the respective processors.

Processors 470, 480 may each exchange information with a chipset 490 via individual P-P interfaces 452, 454 using point to point interface circuits 476, 494, 486, 498. Chipset 490 may optionally exchange information with the coprocessor 438 via a high-performance interface 439. In one embodiment, the coprocessor 438 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 490 may be coupled to a first bus 416 via an interface 496. In one embodiment, first bus 416 may be a Peripheral Component Interconnect (PCI) bus, or a bus such as a PCI Express bus or another third generation I/O interconnect bus, although the scope of the present invention is not so limited.

As shown in FIG. 4, various I/O devices 414 may be coupled to first bus 416, along with a bus bridge 418 which couples first bus 416 to a second bus 420. In one embodiment, one or more additional processor(s) 415, such as coprocessors, high-throughput MIC processors, GPGPU's, accelerators (such as, e.g., graphics accelerators or digital signal processing (DSP) units), field programmable gate arrays, or any other processor, are coupled to first bus 416. In one embodiment, second bus 420 may be a low pin count (LPC) bus. Various devices may be coupled to a second bus 420 including, for example, a keyboard and/or mouse 422, communication devices 427 and a storage unit 428 such as a disk drive or other mass storage device which may include instructions/code and data 430, in one embodiment. Further, an audio I/O 424 may be coupled to the second bus 420. Note that other architectures are possible. For example, instead of the point-to-point architecture of FIG. 4, a system may implement a multi-drop bus or other such architecture.

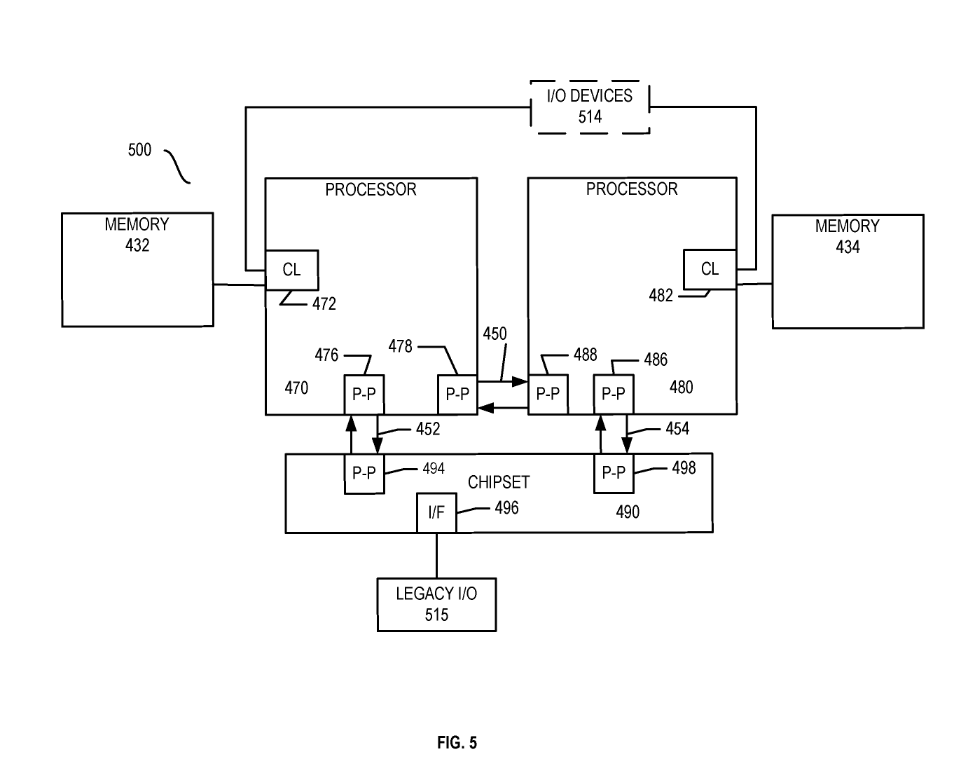

Referring now to FIG. 5, shown is a block diagram of a second more specific exemplary system 500 in accordance with an embodiment of the present invention. Like elements in FIGS. 4 and 5 bear like reference numerals, and certain aspects of FIG. 4 have been omitted from FIG. 5 in order to avoid obscuring other aspects of FIG. 5.

FIG. 5 illustrates that the processors 470, 480 may include integrated memory and I/O control logic (“CL”) 472 and 482, respectively. Thus, the CL 472, 482 include integrated memory controller units and include I/O control logic. FIG. 5 illustrates that not only are the memories 432, 434 coupled to the CL 472, 482, but also that I/O devices 514 are also coupled to the control logic 472, 482. Legacy I/O devices 515 are coupled to the chipset 490.

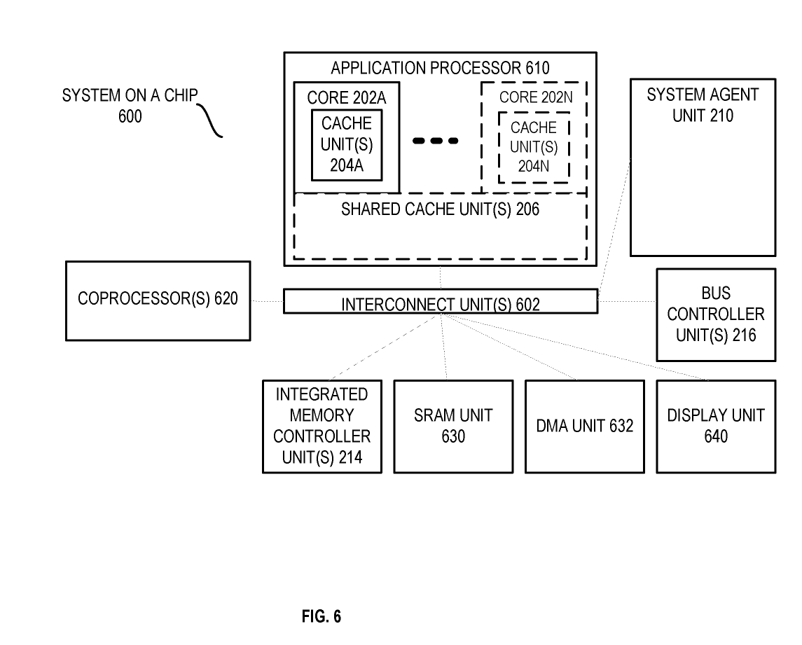

Referring now to FIG. 6, shown is a block diagram of a SoC 600 in accordance with an embodiment of the present invention. Similar elements in FIG. 2 bear like reference numerals. Also, dashed lined boxes are optional features on more advanced SoCs. In FIG. 6, an interconnect unit(s) 602 is coupled to: an application processor 610 which includes a set of one or more cores 202A-N and shared cache unit(s) 206; a system agent unit 210; a bus controller unit(s) 216; an integrated memory controller unit(s) 214; a set or one or more coprocessors 620 which may include integrated graphics logic, an image processor, an audio processor, and a video processor; an static random access memory (SRAM) unit 630; a direct memory access (DMA) unit 632; and a display unit 640 for coupling to one or more external displays. In one embodiment, the coprocessor(s) 620 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 430 illustrated in FIG. 4, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

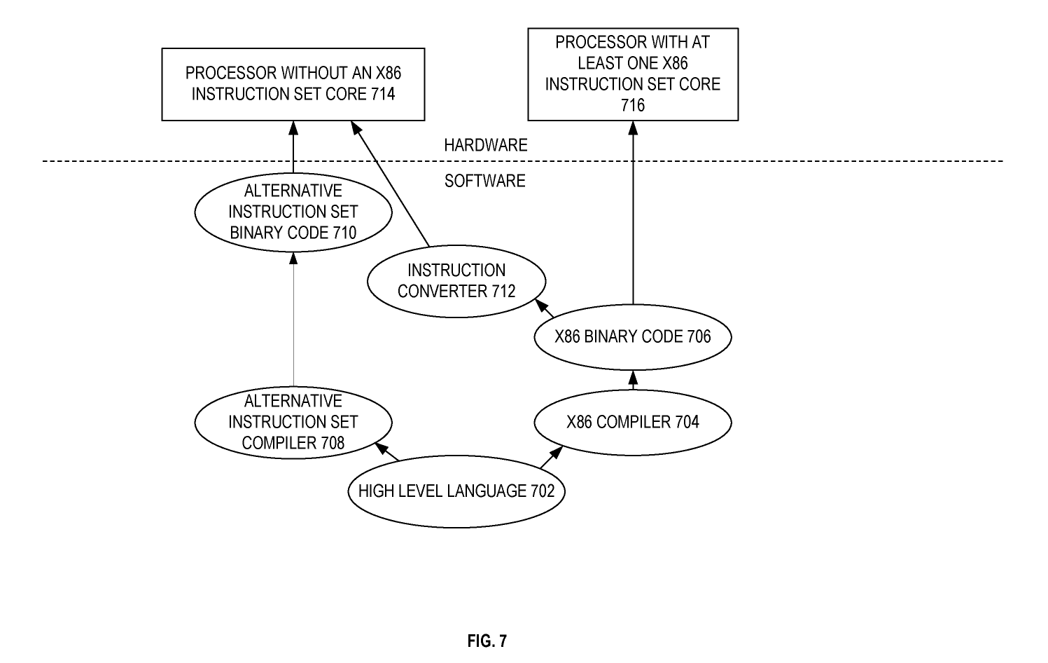

FIG. 7 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 7 shows a program in a high level language 702 may be compiled using an x86 compiler 704 to generate x86 binary code 706 that may be natively executed by a processor with at least one x86 instruction set core 716. The processor with at least one x86 instruction set core 716 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 704 represents a compiler that is operable to generate x86 binary code 706 (e.g., object code) that can, with or without additional linkage processing, be executed on the processor with at least one x86 instruction set core 716.

Similarly, FIG. 7 shows the program in the high level language 702 may be compiled using an alternative instruction set compiler 708 to generate alternative instruction set binary code 710 that may be natively executed by a processor without at least one x86 instruction set core 714 (e.g., a processor with cores that execute the MIPS instruction set of MIPS Technologies of Sunnyvale, Calif. and/or that execute the ARM instruction set of ARM Holdings of Sunnyvale, Calif.). The instruction converter 712 is used to convert the x86 binary code 706 into code that may be natively executed by the processor without an x86 instruction set core 714. This converted code is not likely to be the same as the alternative instruction set binary code 710 because an instruction converter capable of this is difficult to make; however, the converted code will accomplish the general operation and be made up of instructions from the alternative instruction set. Thus, the instruction converter 712 represents software, firmware, hardware, or a combination thereof that, through emulation, simulation or any other process, allows a processor or other electronic device that does not have an x86 instruction set processor or core to execute the x86 binary code 706.

### Apparatus and Method for Performing a Vector Horizontal Binary Logical Instruction

As mentioned above, applying binary functions to a series of bit vectors or Boolean matrices may cause inefficiencies. Thus, a more efficient method of applying such functions is desirable. In particular, in some embodiments of the invention, the outputs of two functions to be applied to a series of bit arrays are stored within an 8 bit immediate operand. In some embodiments, each position in the most significant four (high) bits of the 8 bit immediate operand and each position in the least significant four (low) bits of the 8 bit immediate operand are each indexed using two-bit values (i.e., a bit in the second position of the low bits may be indexed as “01”). In some embodiments, the bit values of the high bits and the low bits of the immediate operand indicate the output of a function that operates on two single bit inputs, where these inputs are specified by the first and second bit of the two bit value of the position for the high bits or the low bits.

In some embodiments, each bit of the first source packed data operand and the corresponding bit of the destination packed data operand are used as a two-bit value for an index position for the low bits of the immediate operand. When one of this first set of two-bit values indicates a position in the low bits of the immediate operand that has a value of “1”, in some embodiments, each bit of the second source packed data operand and the corresponding bit of the destination packed data operand are used as a two-bit value for an index position for the high 4 bits of the immediate operand. The value in the high bits of the immediate operand indicated by this second set of two-bit values are then placed into the corresponding position in the register indicated by the destination packed data operand. When none of the first set of two-bit values indicates a position in the low bits of the immediate operand with a value of “1” (i.e., all the values indicate a position in the low bits with a value of “0”), then in some embodiments the values of the register indicated by the destination packed data operand are replaced by “0”.

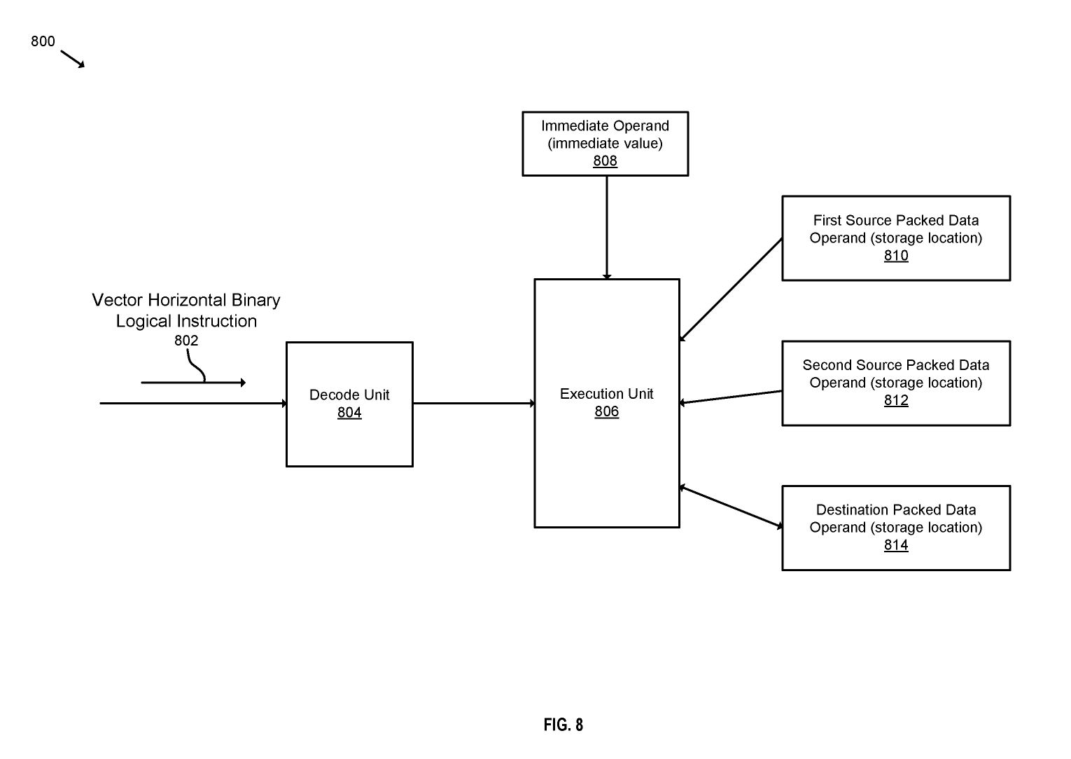

FIG. 8 is a block diagram illustrating a system 800 that is operable to perform an embodiment of a vector horizontal binary logical instruction. In some embodiments, system 800 may be part of a general-purpose processor (e.g., of the type commonly used in desktop, laptop, or other computers). Alternatively, system 800 may be a special-purpose processor. Examples of suitable special-purpose processors include, but are not limited to, cryptographic processors, network processors, communications processors, co-processors, graphics processors, embedded processors, digital signal processors (DSPs), and controllers (e.g., microcontrollers), to name just a few examples. The processor may be any of various complex instruction set computing (CISC) processors, various reduced instruction set computing (RISC) processors, various very long instruction word (VLIW) processors, various hybrids thereof, or other types of processors.

During operation, the system 800 may receive the embodiment of the vector horizontal binary logical instruction 802 (hereafter referred to as instruction 802). For example, the instruction 802 may be received from an instruction fetch unit, an instruction queue, or the like. The instruction 802 may represent a macroinstruction, assembly language instruction, machine code instruction, or other instruction or control signal of an instruction set of the processor. In some embodiments, the instruction 802 may explicitly specify (e.g., through one or more fields or a set of bits), or otherwise indicate (e.g., implicitly indicate), a first source packed data operand 810, and may explicitly specify or otherwise indicate a second source packed data operand 812. The instruction 802 may also explicitly specify or otherwise indicate a destination packed data operand 814, and may explicitly specify or otherwise indicate an immediate operand 808.

Referring again to FIG. 8, the system 800 includes a decode unit or decoder 804. The decode unit may receive and decode instructions, including the instruction 802. The decode unit may output one or more microinstructions, micro-operations, micro-code entry points, decoded instructions or control signals, or other relatively lower-level instructions or control signals that reflect, represent, and/or are derived from the instruction 802. The one or more relatively lower-level instructions or control signals may implement the relatively higher-level instruction 802 through one or more relatively lower-level (e.g., circuit-level or hardware-level) operations. In some embodiments, the decode unit 804 may include one or more input structures (e.g., input port(s), input interconnect(s), an input interface, etc.) to receive the instruction 802, an instruction recognition logic coupled with the input structures to receive and recognize the instruction 802, a decode logic coupled with the recognition logic to receive and decode the instruction 802, and one or more output structures (e.g., output port(s), output interconnect(s), an output interface, etc.) coupled with the decode logic to output one or more corresponding lower level instructions or control signals. The recognition logic and the decode logic may be implemented using various different mechanisms including, but not limited to, microcode read only memories (ROMs), look-up tables, hardware implementations, programmable logic arrays (PLAs), and other mechanisms used to implement decode units known in the art. In some embodiments, decode unit 804 may be the same as decode unit 140 as illustrated in FIG. 1.

The system 800 may also include a set of registers. In some embodiments, the registers may include general-purpose registers operable to hold data. The term general-purpose is often used to refer to an ability to store data or addresses in the registers, although this is not required. Each of the general-purpose registers may represent an on-die storage location that is operable to store data. The general-purpose registers may represent architecturally-visible registers (e.g., an architectural register file). The architecturally-visible or architectural registers are visible to software and/or a programmer and/or are the registers indicated by instructions to identify operands. These architectural registers are contrasted to other non-architectural or non-architecturally visible registers in a given microarchitecture (e.g., temporary registers, reorder buffers, retirement registers, etc.). The registers may be implemented in different ways in different microarchitectures using well-known techniques and are not limited to any particular type of circuit. Various different types of registers are suitable. Examples of suitable types of registers include, but are not limited to, dedicated physical registers, dynamically allocated physical registers using register renaming, and combinations thereof.

In some embodiments, the first source packed data operand 810 may be stored in a first general-purpose register, the second source packed data operand 812 may be stored in a second general-purpose register, the destination packed data operand 814 may be stored in a third general-purpose register. Alternatively, memory locations, or other storage locations, may be used for one or more of the source operands. For example, in some embodiments, memory operations may potentially be used for the second source packed data operand, although this is not required.

Execution unit 806 receives the control signals from decode unit 804 and executes instruction 802. Execution unit is instructed to receive an immediate 8 bit value, a first source storage location, a second source storage location, and a destination storage location. These may be indicated by the immediate operand 808, the first source packed data operand, the second source packed data operand, and the destination source packed data operand, respectively. In some embodiments, the storage locations indicate registers, e.g., physical register file unit 158. In some embodiments, the storage locations indicate memory locations, such as a location in a memory unit, e.g., memory unit 170. The operations and functionality of the execution unit 806 may be described with further detail with reference to execution engine unit 150 in FIG. 1.

Referring again to FIG. 8, the execution unit 806 is coupled with the decode unit 804 and the registers. By way of example, the execution unit may include an arithmetic unit, an arithmetic logic unit, a digital circuit to perform arithmetic and logical operations, a digital circuit including a multiplier and adders, or the like. The execution unit may receive the one or more decoded or otherwise converted instructions or control signals that represent and/or are derived from the instruction 802. The execution unit may also receive the first source packed data operand 810, the second source packed data operand 812, the destination packed data operand 814, and the immediate operand 808. In some embodiments, the immediate operand has an 8-bit value. In some embodiments, the first source packed data operand 810, the second source packed data operand 812, and the destination packed data operand 814 indicate storage locations with values that are multiples of 64 bits up to 512 bits. The execution unit is operable in response to and/or as a result of the instruction 802 (e.g., in response to one or more instructions or control signals decoded directly or indirectly (e.g., through emulation) from the instruction) to store a result.

In some embodiments, the packed data elements (bits) in the first source packed data operand 810, the second source packed data operand 812, and the destination packed data operand 814 are separated into 64 packed data element (64 bit) sections. In such an embodiment, the operations performed on each 64 packed data element section are repeated, and the execution unit 806 may perform the operations on each 64 packed data element section in parallel or sequentially. For each of the one or more 64 packed data element sections, the execution unit 806 determines a bit in the least significant four bits (low bits) of the immediate operand that is indexed by a two-bit index value. The least significant bit of this two-bit index value is a packed data element from a position within a 64 packed data element section of the first source packed data operand. The most significant bit of this two-bit index value is a corresponding packed data element from the corresponding position of the destination packed data operand. For each 64 packed data element section, the execution unit 806 calculates the various two-bit index values derived from the first source packed data operand 810 and the destination packed data operand 814, and determines the bit value from the low bits of the immediate operand 808 that correspond to these two-bit index values. If none of the bit values from the low bits of the immediate operand 808 are determined to be “1”, the execution unit 806 stores a “0” value at all 64 packed data elements of the corresponding 64 packed data element section in the destination packed data operand.

Otherwise, if any of the bit values from the low bits of the immediate operand 808 are determined to be “1,” the execution unit 806 determines the bit value from the most significant four bits (high bits) of the immediate operand using a two-bit index value having as its least significant bit a packed data element in the second source packed data operand and as its most significant bit a packed data element in the destination packed data operand. For each position in the 64 packed data element section of the destination packed data operand, the execution unit 806 stores the bit value from the high bits of the immediate operand, determined using the corresponding two-bit position value derived from a corresponding positions in the second source packed data operand and the destination packed data operand, into the corresponding position of the register or storage location indicated by the destination packed data operand.

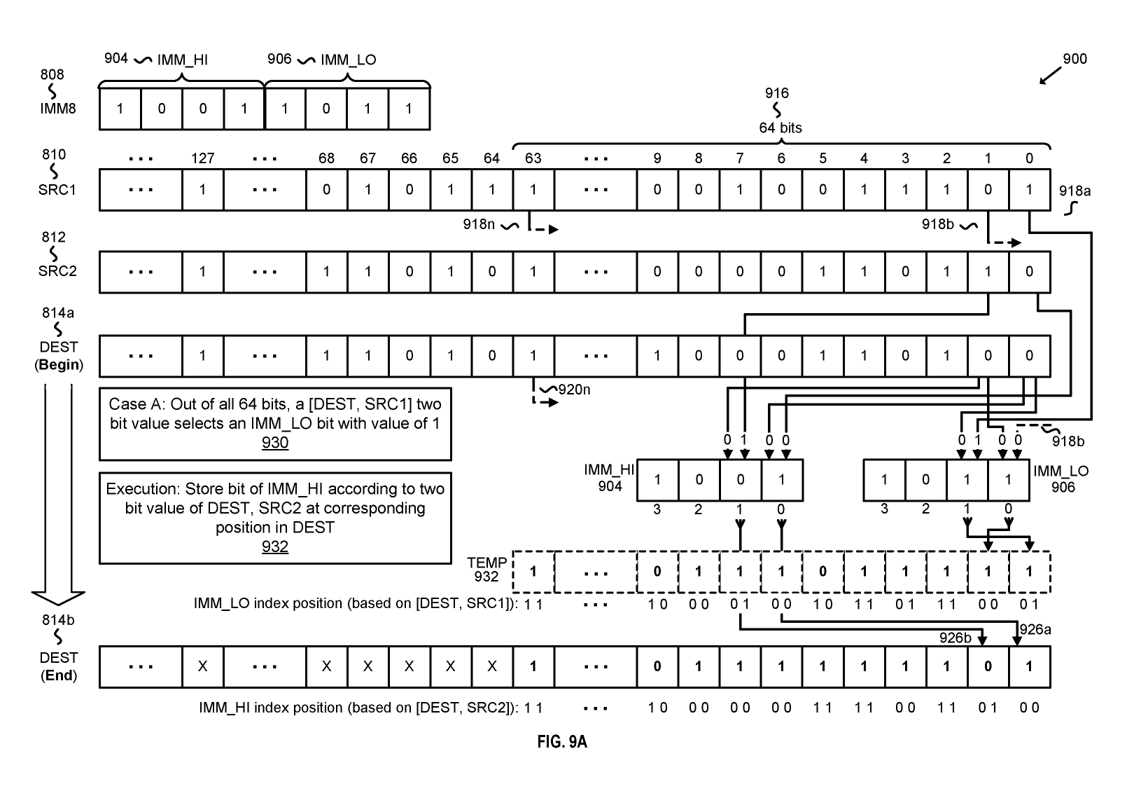

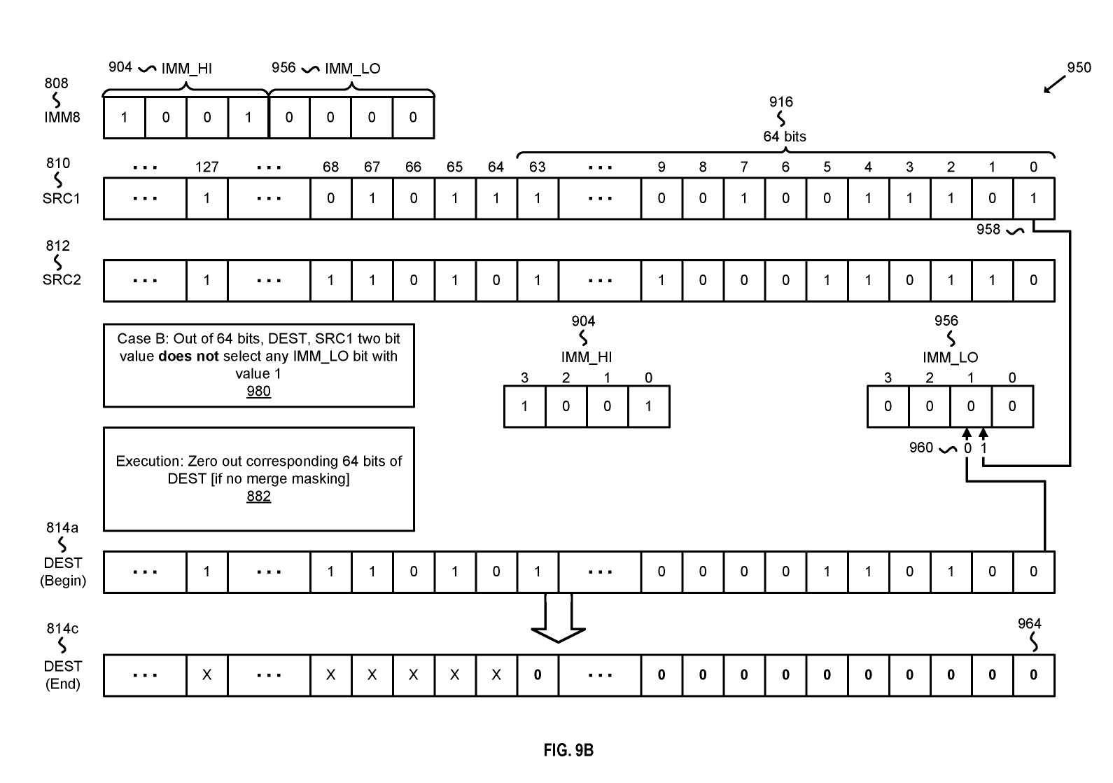

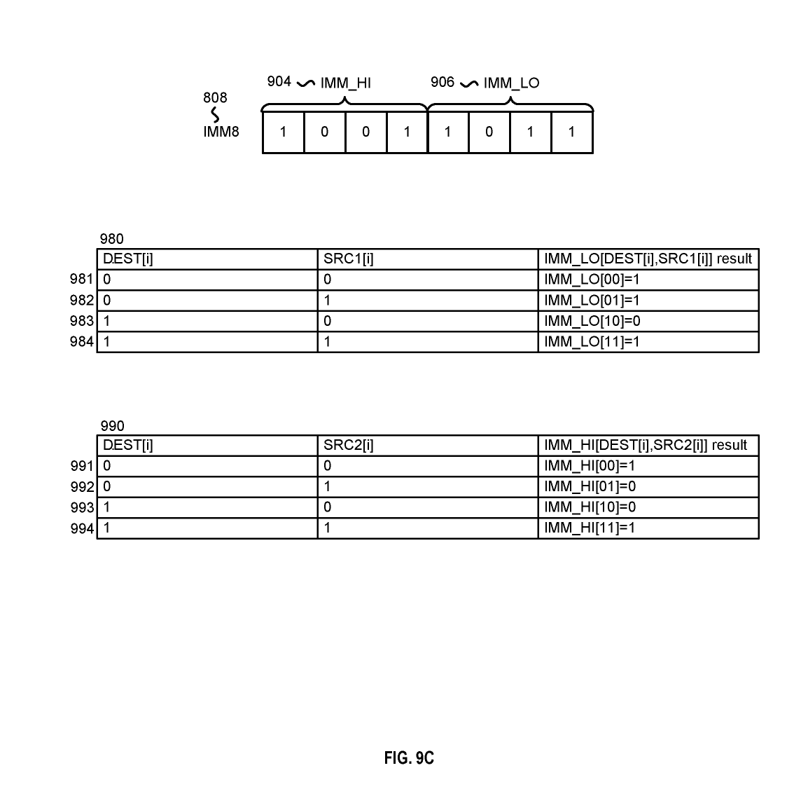

These embodiments described above allow the system 800 to efficiently apply two binary functions, whose outputs are stored in the immediate operand, to a series of Boolean matrices or vectors (represented by the operands), where the application of one function depends upon the output of the other function. This may especially be useful in the case of calculating Boolean matrix inversion (e.g. using Gaussian elimination). Further details regarding the above embodiments will be described below with reference to FIGS. 9A-9B.

The execution unit and/or the processor may include specific or particular logic (e.g., transistors, integrated circuitry, or other hardware potentially combined with firmware (e.g., instructions stored in non-volatile memory) and/or software) that is operable to perform the instruction 802 and/or store the result in response to and/or as a result of the instruction 802 (e.g., in response to one or more instructions or control signals decoded or otherwise derived from instruction 802). In some embodiments, the execution unit may include one or more input structures (e.g., input port(s), input interconnect(s), an input interface, etc.) to receive source operands, circuitry or logic (e.g., a multiplier and at least one adder) coupled with the input structure(s) to receive and process the source operands and generate the result operand, and one or more output structures (e.g., output port(s), output interconnect(s), an output interface, etc.) coupled with the circuitry or logic to output the result operand.

To avoid obscuring the description, a relatively simple system 800 has been shown and described. In other embodiments, the system 800 may optionally include other well-known processor components. Possible examples of such components include, but are not limited to, an instruction fetch unit, instruction and data caches, second or higher level caches, out-of-order execution logic, an instruction scheduling unit, a register renaming unit, a retirement unit, a bus interface unit, instruction and data translation lookaside buffers, prefetch buffers, microinstruction queues, microinstruction sequencers, other components included in processors, and various combinations thereof. Numerous different combinations and configurations of such components are suitable. Embodiments are not limited to any known combination or configuration. Moreover, embodiments may be included in processors have multiple cores, logical processors, or execution engines at least one of which has a decode unit and an execution unit to perform an embodiment of instruction 802.

FIG. 9A illustrates logic 900 for performing a vector horizontal binary logical operation in accordance with one embodiment of the invention. In some embodiments, the execution unit 806 includes logic 900 to execute the instruction 802. In some embodiments, the instruction 802 specifies an immediate operand 808 (IMM8), a first source packed data operand 810 (SRC1), a second source packed data operand 812 (SRC2), and a destination packed data operand 814 (DEST). While the operands depicted in logic 900 include specific binary values, these values are included for illustrative purposes only and the operands may in other embodiments include different values. Note that an “X” displayed in a particular bit location may indicate that the value of these particular bits are not relevant to the current description.

The values in the immediate operand are separated into the four most significant bits, IMM_HI 904, and the four least significant bits, IMM_LO 806. These may represent the outputs of two functions that each accept as inputs two binary values. For example, a function may output the value “1” for the inputs “0” and “0”, output “0” for the inputs “0” and “1”, output “1” for the inputs “1” and “0”, and output “0” for the inputs “1” and “1”. In such a case, the function may be modeled as the 4-bit binary value “1010”. To find the output for the function for the inputs “1” and “0”, the system may determine the output value from the 4-bit binary value “1010” using the two-bit position “10”, which is composed of the inputs “1” and “0”. This 4-bit binary value may be the least significant four bits of an 8-bit value, and another 4-bit binary value may form the most significant 4 bits of the 8-bit value, allowing the 8-bit value to define the output of two binary functions.

As noted above, SRC1 810, SRC2 812, and DEST 814 may be registers that can store up to 512 bits (512 packed data elements). In some embodiments, logic 900 operates separately on sets of 64 bits (packed data elements) of SRC1 810, SRC2 812, and DEST 814, and so the operations on one packed data element does not affect the operations or results of another packed data element. For a register with 512 bits, there may be a total of 8 64-bit packed data elements, however the instruction 802 may specify to the processor to operate on a fewer number of 64-bit packed data elements. For illustrative purposes, FIG. 9A shows operations on the least significant 64 bits of the storage location represented by the operands. These are bits 0 to 63, indicated by 916.

FIG. 9A further illustrates the first conditional outcome of logic 900. At block 930, execution unit 806 executes logic 900 by determining the IMM_LO 906 values which are indexed by the respective values in SRC1 810 and the values in the beginning (initial) state of DEST 814a (i.e., before new values are stored in the storage location indicated by DEST). Thus, at 918a, the execution unit 806 takes the value “1” from position 0 in SRC1 810 along with the value “1” from the same position 0 in DEST1 814a at 920a to form the two-bit index value “01”, with the value from SRC1 810 being the least significant bit of the two-bit index value and the value from DEST1 814a being the most significant bit of the two-bit value. This two-bit index value “01” is used by the execution unit 806 to index the value of IMM_LO 906 at bit position 1 (i.e., bit position 1 corresponds to binary value “01”).

Execution unit 806 iterates (either serially or in parallel) through the remaining packed data elements 918b-918n in SRC1 810 and 920b-920n in DEST 814a and determines the corresponding IMM_LO 906 value for all of these 64 positions of SRC1 810 and DEST 814a. For example, in the illustrated example of FIG. 9A, at the next position in the 64 positions (position 1), the execution unit 806 combines value “0” at 918b from SRC1 810 with value “1” from DEST 814a at 920b to form the two-bit index value “10” which is used to determine the value “0” at position 2 (i.e., “10” in binary) of IMM_LO.

In some embodiments, the values determined from IMM_LO are stored in a temporary storage location, such as TEMP 932. As shown in FIG. 9A, once the IMM_LO value is determined, that value is stored in the corresponding position in TEMP 932. For example, at position 0, the IMM_LO value using DEST (“0”) and SRC1 (“1”) is determined by the execution unit to be “1”, and so a “1” is stored at position 0 in TEMP 932. In some embodiments, this temporary storage location is a single bit, and a bitwise OR is performed between each result determined from IMM_LO and this temporary bit, and the result is stored back into the temporary bit. Thus, after processing all 64 packed data elements of a 64-bit section, this temporary bit indicates a “1” if a “1” value was ever determined from IMM_LO for any DEST, SRC1 index position combination, and this temporary bit indicates a “0” otherwise.

In the first conditional outcome illustrated in FIG. 9A, at least one of the determined IMM_LO 906 values based on the two-bit index positions (of DEST and SRC1) is a “1”. This determination of a “1” value may be due to the values in SRC1 810 and DEST 814a or due to the values in IMM_LO 906. Thus, depending on the values in SRC1, DEST, or IMM_LO, the execution unit 806 may determine that at least one of the two-bit index positions from the 64 different SRC1 810 and DEST 814a combinations indicates a “1” value in IMM_LO 906.

As the execution unit 806 determines that at least one of the two-bit index positions yields a “1” value in IMM_LO 906, execution proceeds at block 932 where the execution unit 806 stores new values in DEST 814b (which represents the state of the storage location indicated by DEST after the execution unit 806 completes the execution of instruction 802) based on a value in IMM_HI 904 indicated by a different two-bit value that has as a most significant bit a packed data element at a position in SRC2 812 and as least significant bit a packed data element at the same position in DEST 814a. As illustrated in FIG. 9A, position 0 in SRC2 812 has a value of “0”, and the corresponding value in DEST 814a has a value of “0”. These two values form a two-bit index position of “00”, which corresponds to position 0 in IMM_HI 904. The value at position 0 of IMM_HI 904 is “1”, and thus this value of “1” is stored at 926a in the register indicated by DEST 814b at the same position 0. The execution unit repeats this process for all remaining 63 positions in SRC2 812 and DEST 814a and places the new values in the corresponding positions of DEST 814b.

After the execution unit 806 completes the execution of the instruction 802, the values stored in the register indicated by DEST 814b are changed. If the values of IMM_LO 906 represent the outputs of a first two input, one output binary function, and the values of IMM_HI 904 represent the outputs of a second two input, one output binary function, then the values of DEST 814b represent the outputs of the function represented by IMM_HI 904 in the case where the output of the function represented by IMM_LO 906 resulted in a particular result (i.e., a “1”). As will be shown with reference to FIG. 9B, in the case where the output of the function represented by IMM_LO 906 does not produce this particular result, the values stored in DEST 814b will be all “0” instead. Thus, this logic 900 representing instruction 802 may be used to efficiently apply a binary function to a set of values conditioned upon the results of another binary function. The values may represent one or more vectors or matrices, and thus this instruction 802 may be advantageous for performing complex matrix or vector operations, such as matrix inversion by Gaussian elimination.

FIG. 9B illustrates another aspect of logic 900 for performing a vector horizontal binary logical operation in accordance with one embodiment of the invention. While FIG. 9A illustrated the first conditional outcome of instruction 802 in logic 900, FIG. 9B illustrates a second conditional outcome of instruction 802 in logic 950. Note that an “X” displayed in a particular bit location may indicate that the value of these particular bits are not relevant to the current description.

To illustrate this second conditional outcome, a different IMM_LO (IMM_LO 956) is used in FIG. 9B with different values from the values of IMM_LO 906 in FIG. 9A. At block 980, execution unit 806 executes logic 900 by determining the IMM_LO 956 values which are indexed by the respective values in SRC1 810 and the beginning state of DEST 814a. Although this operation is similar to that in block 930 of FIG. 9A, in the case of the values of IMM_LO 956 of FIG. 9B, the execution unit 906 determines that no IMM_LO 956 values that are selected are “1”. This may be due to the particular set of values in SRC1 810 and DEST 814a which cause a “1” value never to be selected from IMM_LO, or this may be due to the particular values in IMM_LO 956.

Although the exemplary values of IMM_LO 956 in FIG. 9B are all “0” to emphasize that no “1” value would be selected, a more likely scenario would be that IMM_LO includes both “1” and “0” values and that the combination of the values at the various positions of SRC1 810 and DEST 814a (out of the total 64 positions of the set) do not combine to create a two-bit index position that indicates a “1” value in IMM_LO.

When, after the execution unit 806 iterates through all 64 positions in SRC1 810 and DEST 814a in the method shown above with regards to FIG. 9A, and a “1” is not selected in IMM_LO, then at block 882 a “0” value is stored in those 64 positions of DEST 814a as shown in DEST 814c, which represents the values in the storage indicated by DEST 814c at the end of the execution of the instruction 802 in this second path to the conditional.

FIG. 9C illustrates two tables showing how DEST 814a, SRC1 810, and SRC2 812 may be used as index positions for IMM_HI 904 and IMM_LO 906 according to an embodiment of the invention. While the operands depicted in FIG. 9C include specific binary values, these values are included for illustrative purposes only and the operands may in other embodiments include different values.

Table 980 indicates the value that an execution unit may determine from IMM_LO based on a bit from DEST as the most significant bit of an index position and a bit from the corresponding position in SRC1 as the least significant bit of the index position. Thus, at line 981, when the bit from DEST is “0”, and the bit from SRC1 is “0”, the index position for IMM_LO is “00” in binary, or 0 in decimal, and the value “1” from the position 0 in IMM_LO is determined to be the IMM_LO value for this combination of DEST and SRC1.

Similarly, at line 982, a DEST value of “0” and a SRC1 value of “1” yields a position of 1, which corresponds to the value “1” in IMM_LO. Similar results are seen in lines 983 and 984.

Table 990 indicates the value that an execution unit may determine from IMM_HI based on a bit from DEST as the most significant bit of an index position and a bit from the corresponding position in SRC2 as the least significant bit of the index position. As noted above, the lookup of IMM_HI may occur when the lookup of IMM_LO using the DEST and SRC1 values as index positions results in at least one “1” value being determined from IMM_LO. The lookup of values in IMM_HI is similar to that in IMM_LO. For example, in line 991, a DEST value of “0” and a SRC2 value of “0” indicates the index position “00” in binary or 0 in decimal, which indicates the value “1” at position 0 of IMM_HI. Similar results are seen in lines 992-994.

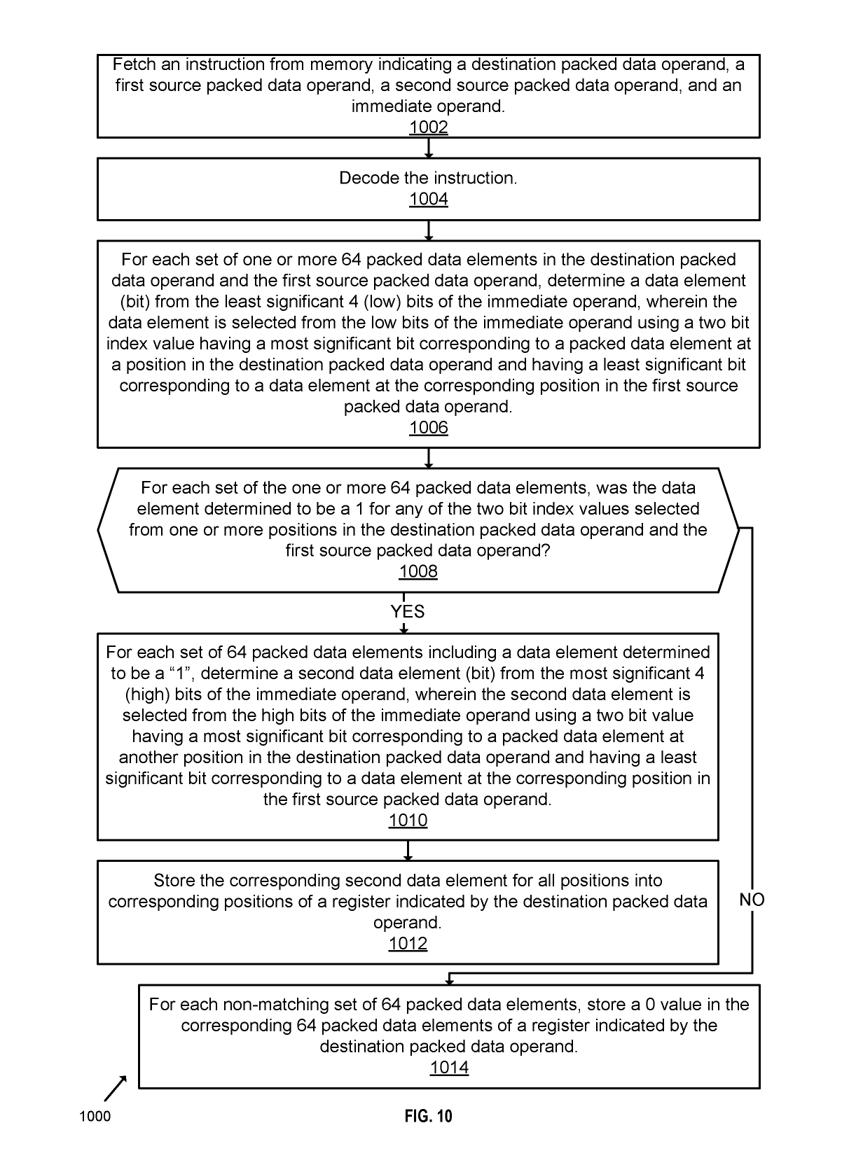

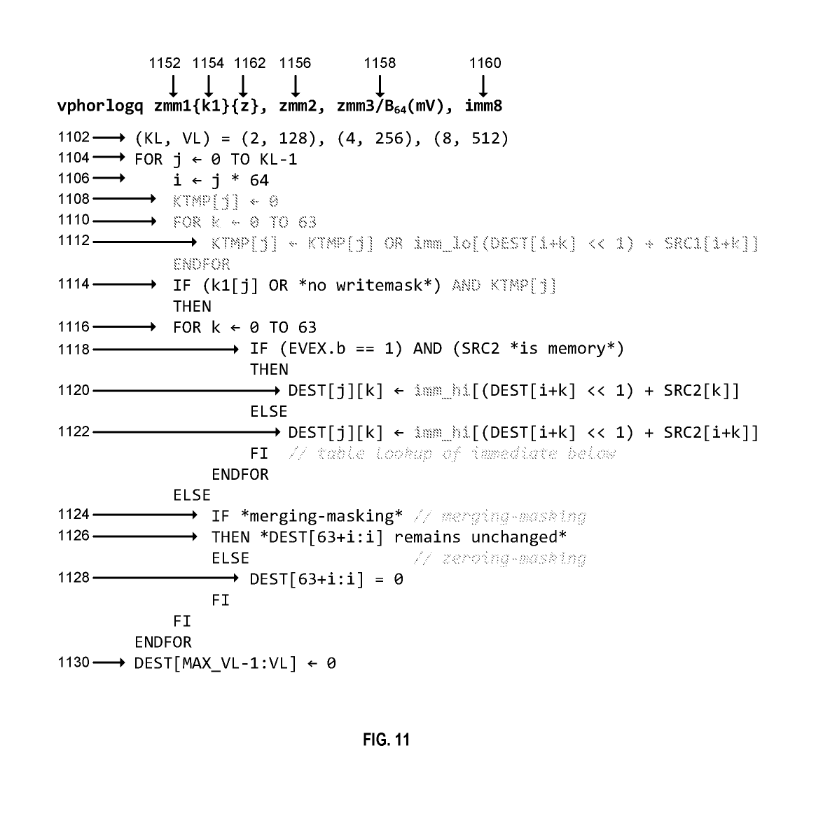

FIG. 10 is a flow diagram of a method 1000 for a system operable to perform an embodiment of a vector horizontal binary logical instruction. In various embodiments, the method may be performed by a processor, instruction processing apparatus, or other digital logic device. In some embodiments, the operations and/or method of FIG. 10 may be performed by and/or within the processor of FIG. 8. The components, features, and specific optional details described herein for the processor of FIG. 8 also optionally apply to the operations and/or method of FIG. 10. Alternatively, the operations and/or method of FIG. 10 may be performed by and/or within a similar or different processor or apparatus, such as those described with reference to FIGS. 1-8. Moreover, the processor of FIG. 8 may perform operations and/or methods the same as, similar to, or different than those of FIG. 10.

The method 1000 includes, at block 1002, fetching an instruction from memory indicating a destination packed data operand, a first source packed data operand, a second source packed data operand, and an immediate operand. In various aspects, the instruction may be fetched and received at a processor, an instruction processing apparatus, or a portion thereof (e.g., an instruction fetch unit, a decode unit, a bus interface unit, etc.). In various aspects, the instruction may be received from an off-die source (e.g., from memory, interconnect, etc.), or from an on-die source (e.g., from an instruction cache, instruction queue, etc.).

At block 1004, the instruction is decoded. In some embodiments, the decoding of the instruction may be performed by a decode unit, such as decode unit 804 in FIG. 8.

At block 1006, the method 1000 includes, for each set of one or more 64 packed data elements in the destination packed data operand and the first source packed data operand, determining a data element (bit) from the least significant 4 (low) bits of the immediate operand, wherein the data element is selected from the low bits of the immediate operand using a two bit index value having a most significant bit corresponding to a packed data element at a position in the destination packed data operand and having a least significant bit corresponding to a data element at the corresponding position in the first source packed data operand. In some embodiments, the determination of the data element is performed by an execution unit such as execution unit 806 in FIG. 8.

At block 1008, the method 1000 includes determining, for each set of the one or more 64 packed data elements, whether the data element was determined to be a “1” for any of the two bit index values selected from one or more positions in the destination packed data operand and the first source packed data operand.

If the determination at block 1008 is affirmative, flow proceeds to block 1010 where the method includes, for each set of 64 packed data elements including a data element determined to be a “1”, determining a second data element (bit) from the most significant 4 (high) bits of the immediate operand, wherein the second data element is selected from the high bits of the immediate operand using a two bit value having a most significant bit corresponding to a packed data element at another position in the destination packed data operand and having a least significant bit corresponding to a data element at the corresponding position in the first source packed data operand.

Flow then proceeds to block 1012, where the method 1000 includes storing the corresponding second data element for all positions into corresponding positions of a register indicated by the destination packed data operand.

If the conditional at block 1008 is determined in the negative, flow proceeds to block 1014, where the method includes, for each non-matching set of 64 packed data elements, storing a “0” value in the corresponding 64 packed data elements of a register indicated by the destination packed data operand.

The illustrated method involves architectural operations (e.g., those visible from a software perspective). In other embodiments, the method may optionally include one or more microarchitectural operations. By way of example, the instruction may be fetched, decoded, scheduled out-of-order, source operands may be accessed, an execution unit may perform microarchitectural operations to implement the instruction, results may be rearranged back into program order, etc. In some embodiments, the microarchitectural operations to implement the instruction may optionally include any of the operations described in FIGS. 1-7 and 12-15.

FIG. 11 is exemplary pseudocode for logic operable to perform an embodiment of a vector horizontal binary logical instruction. In some embodiments, this logic is logic 900. The instruction 802 may specify various operands, as shown in 1152-1160. zmm1 1152 specifies the destination packed data operand. In some embodiments, zmm1 1152 is DEST 814. In some embodiments, the instruction specifies a writemask 1154, in this case “k1”. The values of the writemask may indicate to the execution unit 806 whether or not to write values to a specified portion of the register indicated by the destination packed data operand zmm2 1156 specifies the first source packed data operand. In some embodiments, this is SRC1 810. zmm3 1158 specifies the second source packed data operand. In some embodiments this is SRC2 812. In some embodiments, zmm3 1158 specifies a register, and in other embodiments, zmm3 1158 specifies a memory location. imm8 1160 specifies an immediate operand. In some embodiments, imm8 1160 is IMM8 808 and includes IMM_HI and IMM_LO.

Line 1102 indicates that the instruction is compatible in some embodiments with vector lengths of 128, 256, and 512. The K length indicates the number of sets of 64 packed data elements that the corresponding vector length of binary values may be separated into. As noted above, the instruction operates on sets of 64 packed data elements.

In some embodiments the operand of the instruction specifies an operand indicating a storage location that may store up to 512 bits, and in such a case only a portion of the register is used for the execution of the instruction. In some embodiments, one or more of the operands may indicate a memory storage location instead of a register location.

In FIG. 11, a leftwards pointing arrow indicates that a value on the right side of the arrow is assigned to the variable on the left side of the arrow.

At line 1104, a loop is set to iterate for a number of loops equal to the K length. For example, if the vector length were 128, the K length would be 2, and the loop would iterate two times. In some embodiments, the loop variable is “j”, as illustrated in FIG. 11.

At line 1106, a variable i is set to j multiplied by 64. For example, when j is “2”, the variable i would be “128”.

At line 1108, a temporary variable KTMP, which may be an internal register, is set to the value “0”. In some embodiments KTMP is represented as an array, and the position in the array which is set to “0” is indexed by the variable j (i.e., KTMP[j]). As the loop initiated in line 1104 iterates, j increases in value and the array position for KTMP[j] during each iteration changes.

At line 1110, a second loop, which is an inner loop to the loop from line 1104, is initiated to iterate from 0 to 63, where “k” is the loop variable which iterates from 0 to 63. At line 1112, the temporary value KTMP[j] is set to a value equal to the bitwise OR between KTMP[j] and the value in IMM_LO indexed by a two-bit value composed of the value of DEST at position i+k shifted one bit left added to the value of SRC1 at position i+k. In other words, the two-bit value has as its most significant bit the value of DEST at the position currently being iterated within the current set of 64 packed data elements, and has as its least significant bit the value of SRC1 at the same position. Note that each of the 64 iterations of the loop processes one of the set of 64 packed data elements in both SRC1 and DEST, and that each iteration of the loop indicated at line 1104 processes one set of 64 packed data elements.

As shown in line 1110, the bitwise OR function is repeatedly performed with KTMP[j]. Thus, at the end of the loop indicated by line 1110, KTMP[j] will have the value “1” if any IMM_LO position as indicated by one of the two-bit values described above has the value of “1”, and KTMP[j] will have the value “0” otherwise.

The conditional at line 1114 is predicated on the outcome of the loop indicated by line 1110. If the value of KTMP[j] is “0”, then the lines 1116-1122 following the conditional statement execute. Otherwise, the lines 1124-1128 execute. In some embodiments, the conditional at line 1114 is also predicated on whether the instruction 802 specifies a writemask. If a writemask is specified, then as shown in line 1114, the bit in the writemask at position j should be set to the value “1” for the operations on line 1116-1122 to be executed by the execution unit 806. Otherwise, the operations on lines 1124-1128 are executed instead.

If the conditional on line 1114 results in a “1” or true result, then the loop at line 1116 is executed for 64 iterations with the counter value “k”. In some embodiments, at line 1118, a conditional statement checks to see if SRC2, i.e. the operand specified by zmm2 1158, indicates a memory location. If SRC2 is a memory location, then the values in DEST of the current set of 64 packed data elements that are being processed are replaced with the values of IMM_HI as indexed by a two-bit position value comprised of the original values of DEST at each position of DEST in the current set of 64 packed data elements as the most significant bit and the corresponding value of SRC2 at the corresponding position.

Note that when SRC2 is memory, the operand zmm3 1158 may indicate a memory location that is 64 bits long. This is in contrast to DEST, which indicates a register that is 512 bits long. Thus, while DEST is indexed by “k” but also shifted by the value “i”, where “i” indicates which set of 64 packed data elements in the register that is currently being processed, SRC2 is only indexed by the value “k”.

In some embodiments, the conditional on line 1118 is further predicated such that the following line 1120 only executes if a flag in the instruction prefix indicates that embedded broadcast is on. In some embodiments, this flag is indicated by the term “EVEX.b” and may be set to “1” to indicate that embedded broadcast is set to be on.

Alternatively, if SRC2 is not memory (or if embedded broadcast is not on in some embodiments), then line 1122 is executed instead. This line is similar to line 1120, however SRC2 is indexed by “i+k” instead of only “k”.

Line 1124 executes if the conditional at line 1114 is determined to be “0” or false. In some embodiments, at line 1124, a conditional statement checks to see if merge masking is enabled. In some embodiments, merging masking is indicated by a flag. In some embodiments, this flag is “EVEX.z”. In some embodiments, this flag is indicated by the operand {z} 1162 in the instruction as shown in FIG. 11. Merge masking, or merging masking, indicates to the execution unit to preserve the original values of the destination operand rather than overwrite these values with “0”. If merging masking is on, then the set of 64 packed data elements in DEST that are currently being processed are left unchanged, as shown in line 1126. Otherwise, as shown in line 1128, these values are overridden with “0” (i.e., the value “0” is stored in the corresponding positions of the register indicated by the destination operand).

In some embodiments, at 1130, the remaining values in DEST which were not processed as part of the instruction, i.e., those beyond the vector length specified, are zeroed out (i.e., the value “0” is stored in the corresponding positions of the register indicated by the destination operand).

Although the embodiments above are described with reference to registers that are 512 bits wide, other embodiments of the invention do not require registers with such a length, and the invention may be implemented with registers of any length.

### Exemplary Instruction Formats

Embodiments of the instruction(s) described herein may be embodied in different formats. Additionally, exemplary systems, architectures, and pipelines are detailed below. Embodiments of the instruction(s) may be executed on such systems, architectures, and pipelines, but are not limited to those detailed.

A vector friendly instruction format is an instruction format that is suited for vector instructions (e.g., there are certain fields specific to vector operations). While embodiments are described in which both vector and scalar operations are supported through the vector friendly instruction format, alternative embodiments use only vector operations the vector friendly instruction format.

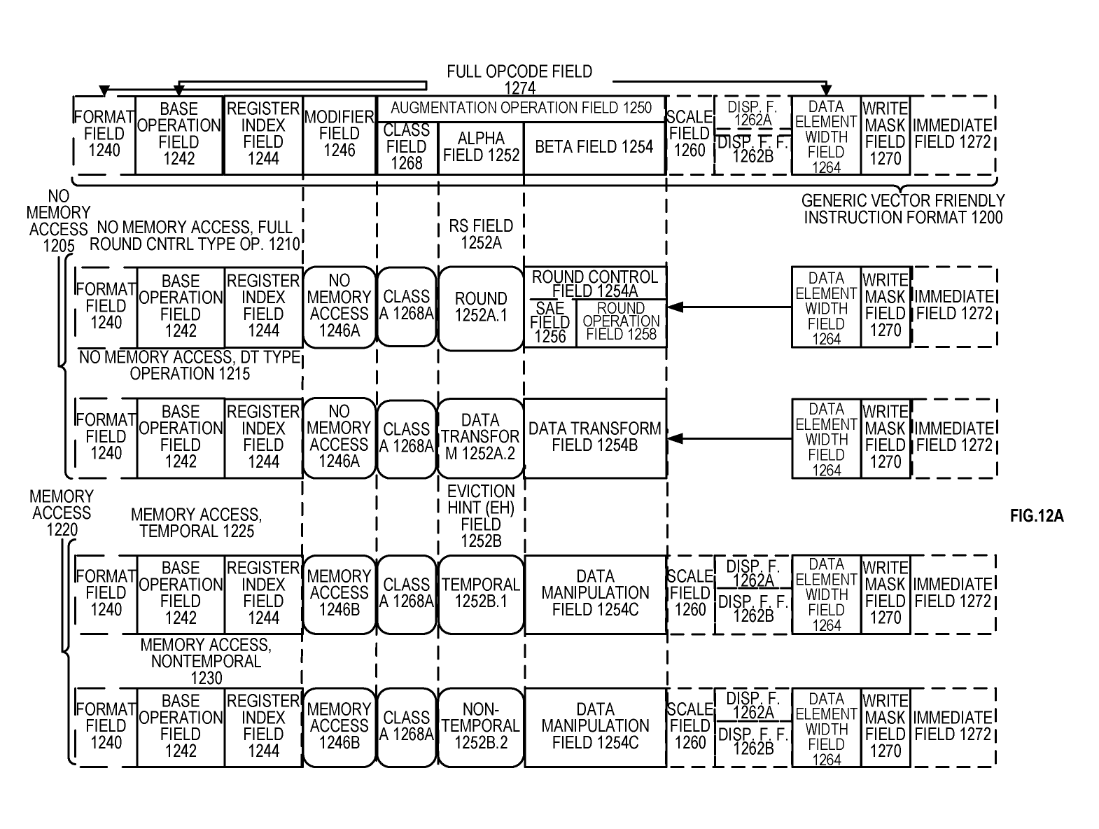

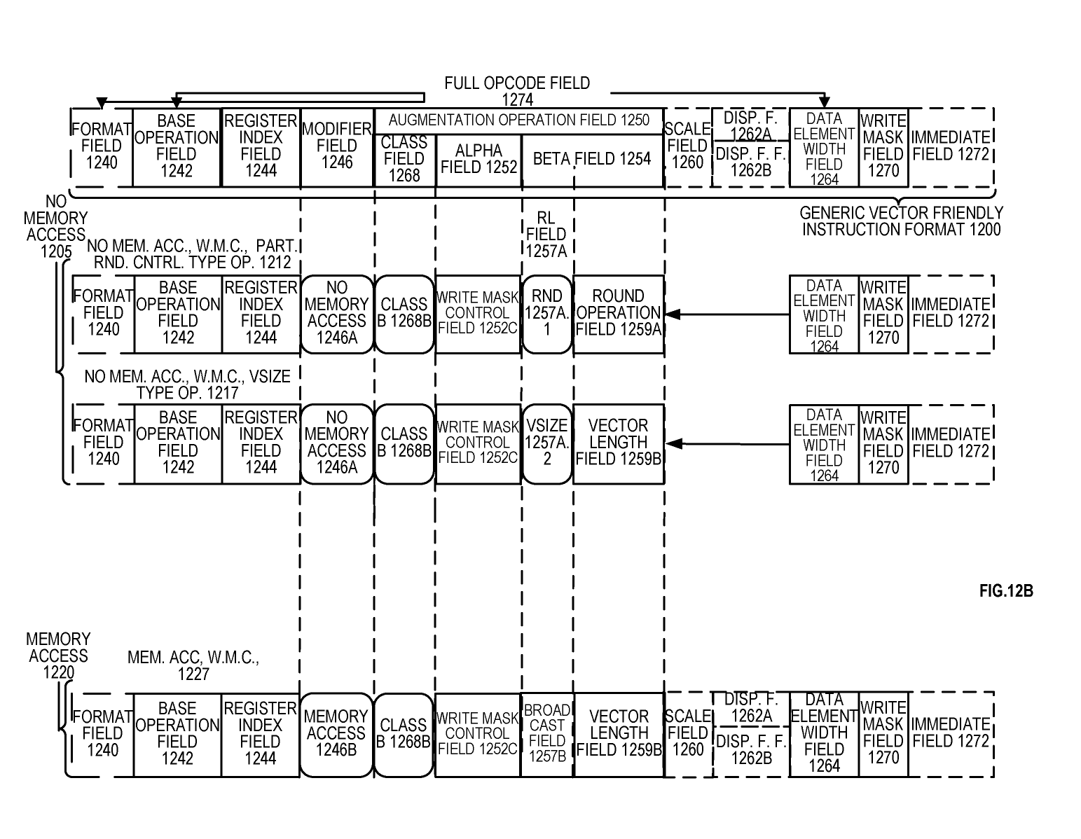

FIGS. 12A-12B are block diagrams illustrating a generic vector friendly instruction format and instruction templates thereof according to embodiments of the invention. FIG. 12A is a block diagram illustrating a generic vector friendly instruction format and class A instruction templates thereof according to embodiments of the invention; while FIG. 12B is a block diagram illustrating the generic vector friendly instruction format and class B instruction templates thereof according to embodiments of the invention. Specifically, a generic vector friendly instruction format 1200 for which are defined class A and class B instruction templates, both of which include no memory access 1205 instruction templates and memory access 1220 instruction templates. The term generic in the context of the vector friendly instruction format refers to the instruction format not being tied to any specific instruction set.

While embodiments of the invention will be described in which the vector friendly instruction format supports the following: a 64 byte vector operand length (or size) with 32 bit (4 byte) or 64 bit (8 byte) data element widths (or sizes) (and thus, a 64 byte vector consists of either 16 doubleword-size elements or alternatively, 8 quadword-size elements); a 64 byte vector operand length (or size) with 16 bit (2 byte) or 8 bit (1 byte) data element widths (or sizes); a 32 byte vector operand length (or size) with 32 bit (4 byte), 64 bit (8 byte), 16 bit (2 byte), or 8 bit (1 byte) data element widths (or sizes); and a 16 byte vector operand length (or size) with 32 bit (4 byte), 64 bit (8 byte), 16 bit (2 byte), or 8 bit (1 byte) data element widths (or sizes); alternative embodiments may support more, less and/or different vector operand sizes (e.g., 256 byte vector operands) with more, less, or different data element widths (e.g., 128 bit (16 byte) data element widths).

The class A instruction templates in FIG. 12A include: 1) within the no memory access 1205 instruction templates there is shown a no memory access, full round control type operation 1210 instruction template and a no memory access, data transform type operation 1215 instruction template; and 2) within the memory access 1220 instruction templates there is shown a memory access, temporal 1225 instruction template and a memory access, non-temporal 1230 instruction template. The class B instruction templates in FIG. 12B include: 1) within the no memory access 1205 instruction templates there is shown a no memory access, write mask control, partial round control type operation 1212 instruction template and a no memory access, write mask control, vsize type operation 1217 instruction template; and 2) within the memory access 1220 instruction templates there is shown a memory access, write mask control 1227 instruction template.

The generic vector friendly instruction format 1200 includes the following fields listed below in the order illustrated in FIGS. 12A-12B.

Format field 1240—a specific value (an instruction format identifier value) in this field uniquely identifies the vector friendly instruction format, and thus occurrences of instructions in the vector friendly instruction format in instruction streams. As such, this field is optional in the sense that it is not needed for an instruction set that has only the generic vector friendly instruction format.

Base operation field 1242—its content distinguishes different base operations.

Register index field 1244—its content, directly or through address generation, specifies the locations of the source and destination operands, be they in registers or in memory. These include a sufficient number of bits to select N registers from a P×Q (e.g. 32×512, 16×128, 32×1024, 64×1024) register file. While in one embodiment N may be up to three sources and one destination register, alternative embodiments may support more or less sources and destination registers (e.g., may support up to two sources where one of these sources also acts as the destination, may support up to three sources where one of these sources also acts as the destination, may support up to two sources and one destination).

Modifier field 1246—its content distinguishes occurrences of instructions in the generic vector instruction format that specify memory access from those that do not; that is, between no memory access 1205 instruction templates and memory access 1220 instruction templates. Memory access operations read and/or write to the memory hierarchy (in some cases specifying the source and/or destination addresses using values in registers), while non-memory access operations do not (e.g., the source and destinations are registers). While in one embodiment this field also selects between three different ways to perform memory address calculations, alternative embodiments may support more, less, or different ways to perform memory address calculations.

Augmentation operation field 1250—its content distinguishes which one of a variety of different operations to be performed in addition to the base operation. This field is context specific. In one embodiment of the invention, this field is divided into a class field 1268, an alpha field 1252, and a beta field 1254. The augmentation operation field 1250 allows common groups of operations to be performed in a single instruction rather than 2, 3, or 4 instructions.

Scale field 1260—its content allows for the scaling of the index field's content for memory address generation (e.g., for address generation that uses 2^{scale}*index+base).

Displacement Field 1262A—its content is used as part of memory address generation (e.g., for address generation that uses 2^{scale}*index+base+displacement).

Displacement Factor Field 1262B (note that the juxtaposition of displacement field 1262A directly over displacement factor field 1262B indicates one or the other is used)—its content is used as part of address generation; it specifies a displacement factor that is to be scaled by the size of a memory access (N)—where N is the number of bytes in the memory access (e.g., for address generation that uses 2^{scale}*index+base+scaled displacement). Redundant low-order bits are ignored and hence, the displacement factor field's content is multiplied by the memory operands total size (N) in order to generate the final displacement to be used in calculating an effective address. The value of N is determined by the processor hardware at runtime based on the full opcode field 1274 (described herein) and the data manipulation field 1254C. The displacement field 1262A and the displacement factor field 1262B are optional in the sense that they are not used for the no memory access 1205 instruction templates and/or different embodiments may implement only one or none of the two.

Data element width field 1264—its content distinguishes which one of a number of data element widths is to be used (in some embodiments for all instructions; in other embodiments for only some of the instructions). This field is optional in the sense that it is not needed if only one data element width is supported and/or data element widths are supported using some aspect of the opcodes.

Write mask field 1270—its content controls, on a per data element position basis, whether that data element position in the destination vector operand reflects the result of the base operation and augmentation operation. Class A instruction templates support merging-writemasking, while class B instruction templates support both merging- and zeroing-writemasking. When merging, vector masks allow any set of elements in the destination to be protected from updates during the execution of any operation (specified by the base operation and the augmentation operation); in other one embodiment, preserving the old value of each element of the destination where the corresponding mask bit has a 0. In contrast, when zeroing vector masks allow any set of elements in the destination to be zeroed during the execution of any operation (specified by the base operation and the augmentation operation); in one embodiment, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the write mask field 1270 allows for partial vector operations, including loads, stores, arithmetic, logical, etc. While embodiments of the invention are described in which the write mask field's 1270 content selects one of a number of write mask registers that contains the write mask to be used (and thus the write mask field's 1270 content indirectly identifies that masking to be performed), alternative embodiments instead or additional allow the mask write field's 1270 content to directly specify the masking to be performed.

Immediate field 1272—its content allows for the specification of an immediate. This field is optional in the sense that is it not present in an implementation of the generic vector friendly format that does not support immediate and it is not present in instructions that do not use an immediate.

Class field 1268—its content distinguishes between different classes of instructions. With reference to FIGS. 12A-B, the contents of this field select between class A and class B instructions. In FIGS. 12A-B, rounded corner squares are used to indicate a specific value is present in a field (e.g., class A 1268A and class B 1268B for the class field 1268 respectively in FIGS. 12A-B).

### Instruction Templates of Class A

In the case of the non-memory access 1205 instruction templates of class A, the alpha field 1252 is interpreted as an RS field 1252A, whose content distinguishes which one of the different augmentation operation types are to be performed (e.g., round 1252A.1 and data transform 1252A.2 are respectively specified for the no memory access, round type operation 1210 and the no memory access, data transform type operation 1215 instruction templates), while the beta field 1254 distinguishes which of the operations of the specified type is to be performed. In the no memory access 1205 instruction templates, the scale field 1260, the displacement field 1262A, and the displacement scale filed 1262B are not present.

### No-Memory Access Instruction Templates—Full Round Control Type Operation

In the no memory access full round control type operation 1210 instruction template, the beta field 1254 is interpreted as a round control field 1254A, whose content(s) provide static rounding. While in the described embodiments of the invention the round control field 1254A includes a suppress all floating point exceptions (SAE) field 1256 and a round operation control field 1258, alternative embodiments may support may encode both these concepts into the same field or only have one or the other of these concepts/fields (e.g., may have only the round operation control field 1258).

SAE field 1256—its content distinguishes whether or not to disable the exception event reporting; when the SAE field's 1256 content indicates suppression is enabled, a given instruction does not report any kind of floating-point exception flag and does not raise any floating point exception handler.

Round operation control field 1258—its content distinguishes which one of a group of rounding operations to perform (e.g., Round-up, Round-down, Round-towards-zero and Round-to-nearest). Thus, the round operation control field 1258 allows for the changing of the rounding mode on a per instruction basis. In one embodiment of the invention where a processor includes a control register for specifying rounding modes, the round operation control field's 1250 content overrides that register value.

### No Memory Access Instruction Templates—Data Transform Type Operation

In the no memory access data transform type operation 1215 instruction template, the beta field 1254 is interpreted as a data transform field 1254B, whose content distinguishes which one of a number of data transforms is to be performed (e.g., no data transform, swizzle, broadcast).

In the case of a memory access 1220 instruction template of class A, the alpha field 1252 is interpreted as an eviction hint field 1252B, whose content distinguishes which one of the eviction hints is to be used (in FIG. 12A, temporal 1252B.1 and non-temporal 1252B.2 are respectively specified for the memory access, temporal 1225 instruction template and the memory access, non-temporal 1230 instruction template), while the beta field 1254 is interpreted as a data manipulation field 1254C, whose content distinguishes which one of a number of data manipulation operations (also known as primitives) is to be performed (e.g., no manipulation; broadcast; up conversion of a source; and down conversion of a destination). The memory access 1220 instruction templates include the scale field 1260, and optionally the displacement field 1262A or the displacement scale field 1262B.

Vector memory instructions perform vector loads from and vector stores to memory, with conversion support. As with regular vector instructions, vector memory instructions transfer data from/to memory in a data element-wise fashion, with the elements that are actually transferred is dictated by the contents of the vector mask that is selected as the write mask.

### Memory Access Instruction Templates—Temporal

Temporal data is data likely to be reused soon enough to benefit from caching. This is, however, a hint, and different processors may implement it in different ways, including ignoring the hint entirely.

### Memory Access Instruction Templates—Non-Temporal

Non-temporal data is data unlikely to be reused soon enough to benefit from caching in the 1st-level cache and should be given priority for eviction. This is, however, a hint, and different processors may implement it in different ways, including ignoring the hint entirely.

### Instruction Templates of Class B

In the case of the instruction templates of class B, the alpha field 1252 is interpreted as a write mask control (Z) field 1252C, whose content distinguishes whether the write masking controlled by the write mask field 1270 should be a merging or a zeroing.

In the case of the non-memory access 1205 instruction templates of class B, part of the beta field 1254 is interpreted as an RL field 1257A, whose content distinguishes which one of the different augmentation operation types are to be performed (e.g., round 1257A.1 and vector length (VSIZE) 1257A.2 are respectively specified for the no memory access, write mask control, partial round control type operation 1212 instruction template and the no memory access, write mask control, VSIZE type operation 1217 instruction template), while the rest of the beta field 1254 distinguishes which of the operations of the specified type is to be performed. In the no memory access 1205 instruction templates, the scale field 1260, the displacement field 1262A, and the displacement scale filed 1262B are not present.

In the no memory access, write mask control, partial round control type operation 1210 instruction template, the rest of the beta field 1254 is interpreted as a round operation field 1259A and exception event reporting is disabled (a given instruction does not report any kind of floating-point exception flag and does not raise any floating point exception handler).

Round operation control field 1259A—just as round operation control field 1258, its content distinguishes which one of a group of rounding operations to perform (e.g., Round-up, Round-down, Round-towards-zero and Round-to-nearest). Thus, the round operation control field 1259A allows for the changing of the rounding mode on a per instruction basis. In one embodiment of the invention where a processor includes a control register for specifying rounding modes, the round operation control field's 1250 content overrides that register value.

In the no memory access, write mask control, VSIZE type operation 1217 instruction template, the rest of the beta field 1254 is interpreted as a vector length field 1259B, whose content distinguishes which one of a number of data vector lengths is to be performed on (e.g., 128, 256, or 512 byte).

In the case of a memory access 1220 instruction template of class B, part of the beta field 1254 is interpreted as a broadcast field 1257B, whose content distinguishes whether or not the broadcast type data manipulation operation is to be performed, while the rest of the beta field 1254 is interpreted the vector length field 1259B. The memory access 1220 instruction templates include the scale field 1260, and optionally the displacement field 1262A or the displacement scale field 1262B.

With regard to the generic vector friendly instruction format 1200, a full opcode field 1274 is shown including the format field 1240, the base operation field 1242, and the data element width field 1264. While one embodiment is shown where the full opcode field 1274 includes all of these fields, the full opcode field 1274 includes less than all of these fields in embodiments that do not support all of them. The full opcode field 1274 provides the operation code (opcode).

The augmentation operation field 1250, the data element width field 1264, and the write mask field 1270 allow these features to be specified on a per instruction basis in the generic vector friendly instruction format.

The combination of write mask field and data element width field create typed instructions in that they allow the mask to be applied based on different data element widths.

The various instruction templates found within class A and class B are beneficial in different situations. In some embodiments of the invention, different processors or different cores within a processor may support only class A, only class B, or both classes. For instance, a high performance general purpose out-of-order core intended for general-purpose computing may support only class B, a core intended primarily for graphics and/or scientific (throughput) computing may support only class A, and a core intended for both may support both (of course, a core that has some mix of templates and instructions from both classes but not all templates and instructions from both classes is within the purview of the invention). Also, a single processor may include multiple cores, all of which support the same class or in which different cores support different class. For instance, in a processor with separate graphics and general purpose cores, one of the graphics cores intended primarily for graphics and/or scientific computing may support only class A, while one or more of the general purpose cores may be high performance general purpose cores with out of order execution and register renaming intended for general-purpose computing that support only class B. Another processor that does not have a separate graphics core, may include one more general purpose in-order or out-of-order cores that support both class A and class B. Of course, features from one class may also be implement in the other class in different embodiments of the invention. Programs written in a high level language would be put (e.g., just in time compiled or statically compiled) into an variety of different executable forms, including: 1) a form having only instructions of the class(es) supported by the target processor for execution; or 2) a form having alternative routines written using different combinations of the instructions of all classes and having control flow code that selects the routines to execute based on the instructions supported by the processor which is currently executing the code.

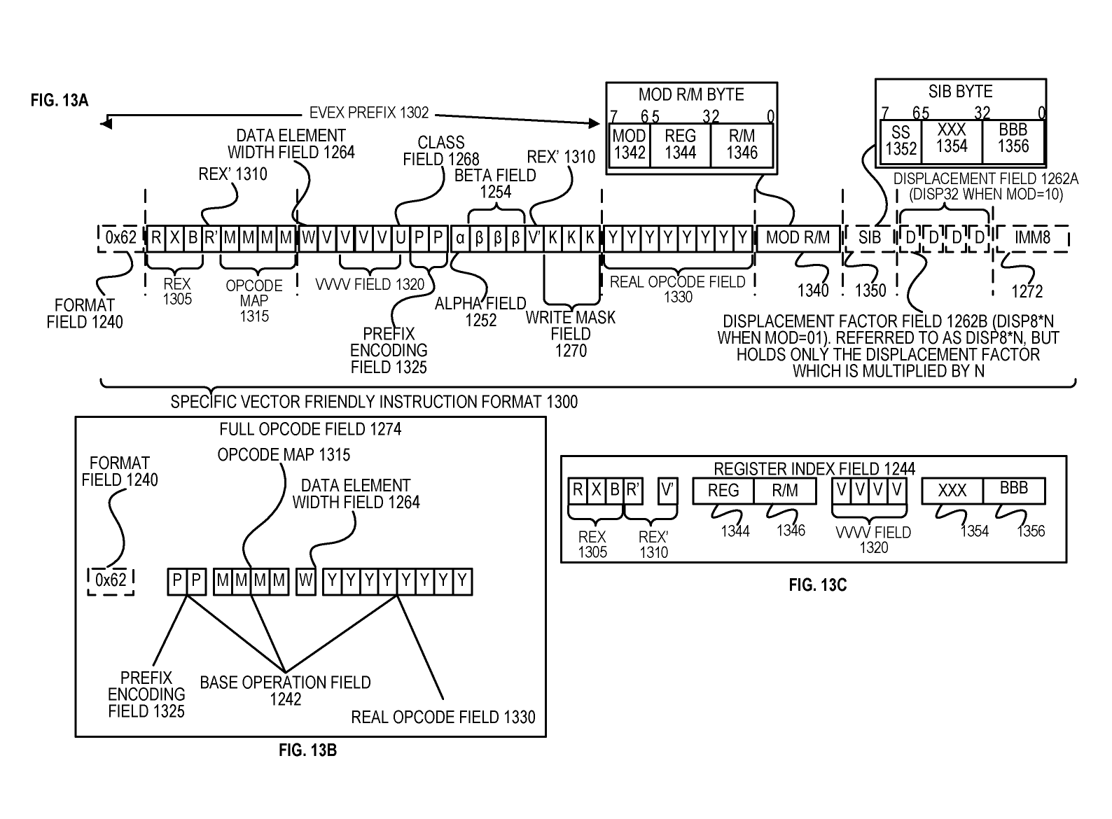

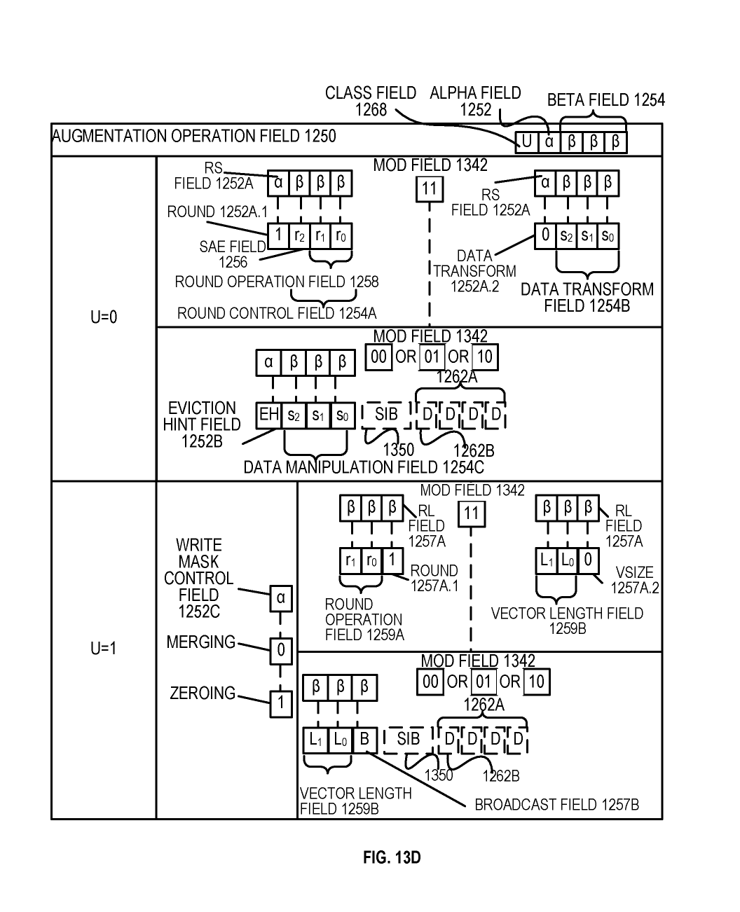

FIG. 13A-D are block diagrams illustrating an exemplary specific vector friendly instruction format according to embodiments of the invention. FIG. 13 shows a specific vector friendly instruction format 1300 that is specific in the sense that it specifies the location, size, interpretation, and order of the fields, as well as values for some of those fields. The specific vector friendly instruction format 1300 may be used to extend the x86 instruction set, and thus some of the fields are similar or the same as those used in the existing x86 instruction set and extension thereof (e.g., AVX). This format remains consistent with the prefix encoding field, real opcode byte field, MOD R/M field, SIB field, displacement field, and immediate fields of the existing x86 instruction set with extensions. The fields from FIG. 12 into which the fields from FIG. 13 map are illustrated.

It should be understood that, although embodiments of the invention are described with reference to the specific vector friendly instruction format 1300 in the context of the generic vector friendly instruction format 1200 for illustrative purposes, the invention is not limited to the specific vector friendly instruction format 1300 except where claimed. For example, the generic vector friendly instruction format 1200 contemplates a variety of possible sizes for the various fields, while the specific vector friendly instruction format 1300 is shown as having fields of specific sizes. By way of specific example, while the data element width field 1264 is illustrated as a one bit field in the specific vector friendly instruction format 1300, the invention is not so limited (that is, the generic vector friendly instruction format 1200 contemplates other sizes of the data element width field 1264).

The generic vector friendly instruction format 1200 includes the following fields listed below in the order illustrated in FIG. 13A.

EVEX Prefix (Bytes 0-3) 1302—is encoded in a four-byte form.

Format Field 1240 (EVEX Byte 0, bits [7:0])—the first byte (EVEX Byte 0) is the format field 1240 and it contains 0x62 (the unique value used for distinguishing the vector friendly instruction format in one embodiment of the invention).

The second-fourth bytes (EVEX Bytes 1-3) include a number of bit fields providing specific capability.

REX field 1305 (EVEX Byte 1, bits [7-5])—consists of a EVEX.R bit field (EVEX Byte 1, bit [7]-R), EVEX.X bit field (EVEX byte 1, bit [6]-X), and 1257BEX byte 1, bit[5]-B). The EVEX.R, EVEX.X, and EVEX.B bit fields provide the same functionality as the corresponding VEX bit fields, and are encoded using is complement form, i.e. ZMM0 is encoded as 1211B, ZMM15 is encoded as 0000B. Other fields of the instructions encode the lower three bits of the register indexes as is known in the art (rrr, xxx, and bbb), so that Rrrr, Xxxx, and Bbbb may be formed by adding EVEX.R, EVEX.X, and EVEX.B.

REX′ field 1210—this is the first part of the REX′ field 1210 and is the EVEX.R′ bit field (EVEX Byte 1, bit [4]-R′) that is used to encode either the upper 16 or lower 16 of the extended 32 register set. In one embodiment of the invention, this bit, along with others as indicated below, is stored in bit inverted format to distinguish (in the well-known x86 32-bit mode) from the BOUND instruction, whose real opcode byte is 62, but does not accept in the MOD R/M field (described below) the value of 11 in the MOD field; alternative embodiments of the invention do not store this and the other indicated bits below in the inverted format. A value of 1 is used to encode the lower 16 registers. In other words, R′Rrrr is formed by combining EVEX.R′, EVEX.R, and the other RRR from other fields.

Opcode map field 1315 (EVEX byte 1, bits [3:0]-mmmm)—its content encodes an implied leading opcode byte (0F, 0F 38, or 0F 3).

Data element width field 1264 (EVEX byte 2, bit [7]-W)—is represented by the notation EVEX.W. EVEX.W is used to define the granularity (size) of the datatype (either 32-bit data elements or 64-bit data elements).

EVEX.vvvv 1320 (EVEX Byte 2, bits [6:3]-vvvv)—the role of EVEX.vvvv may include the following: 1) EVEX.vvvv encodes the first source register operand, specified in inverted (1s complement) form and is valid for instructions with 2 or more source operands; 2) EVEX.vvvv encodes the destination register operand, specified in is complement form for certain vector shifts; or 3) EVEX.vvvv does not encode any operand, the field is reserved and should contain 1211b. Thus, EVEX.vvvv field 1320 encodes the 4 low-order bits of the first source register specifier stored in inverted (1s complement) form. Depending on the instruction, an extra different EVEX bit field is used to extend the specifier size to 32 registers.

EVEX.U 1268 Class field (EVEX byte 2, bit [2]-U)—If EVEX.U=0, it indicates class A or EVEX.U0; if EVEX.U=1, it indicates class B or EVEX.U1.

Prefix encoding field 1325 (EVEX byte 2, bits [1:0]-pp)—provides additional bits for the base operation field. In addition to providing support for the legacy SSE instructions in the EVEX prefix format, this also has the benefit of compacting the SIMD prefix (rather than requiring a byte to express the SIMD prefix, the EVEX prefix requires only 2 bits). In one embodiment, to support legacy SSE instructions that use a SIMD prefix (66H, F2H, F3H) in both the legacy format and in the EVEX prefix format, these legacy SIMD prefixes are encoded into the SIMD prefix encoding field; and at runtime are expanded into the legacy SIMD prefix prior to being provided to the decoder's PLA (so the PLA can execute both the legacy and EVEX format of these legacy instructions without modification). Although newer instructions could use the EVEX prefix encoding field's content directly as an opcode extension, certain embodiments expand in a similar fashion for consistency but allow for different meanings to be specified by these legacy SIMD prefixes. An alternative embodiment may redesign the PLA to support the 2 bit SIMD prefix encodings, and thus not require the expansion.

Alpha field 1252 (EVEX byte 3, bit [7]-EH; also known as EVEX.EH, EVEX.rs, EVEX.RL, EVEX.write mask control, and EVEX.N; also illustrated with α)—as previously described, this field is context specific.

Beta field 1254 (EVEX byte 3, bits [6:4]-SSS, also known as EVEX.s₂₋₀, EVEX.r₂₋₀, EVEX.rr1, EVEX.LL0, EVEX.LLB; also illustrated with βββ)—as previously described, this field is context specific.

REX′ field 1210—this is the remainder of the REX′ field and is the EVEX.V′ bit field (EVEX Byte 3, bit [3]-V′) that may be used to encode either the upper 16 or lower 16 of the extended 32 register set. This bit is stored in bit inverted format. A value of 1 is used to encode the lower 16 registers. In other words, V′VVVV is formed by combining EVEX.V′, EVEX.vvvv.

Write mask field 1270 (EVEX byte 3, bits [2:0]-kkk)—its content specifies the index of a register in the write mask registers as previously described. In one embodiment of the invention, the specific value EVEX.kkk=000 has a special behavior implying no write mask is used for the particular instruction (this may be implemented in a variety of ways including the use of a write mask hardwired to all ones or hardware that bypasses the masking hardware).

Real Opcode Field 1330 (Byte 4) is also known as the opcode byte. Part of the opcode is specified in this field.

MOD R/M Field 1340 (Byte 5) includes MOD field 1342, Reg field 1344, and R/M field 1346. As previously described, the MOD field's 1342 content distinguishes between memory access and non-memory access operations. The role of Reg field 1344 can be summarized to two situations: encoding either the destination register operand or a source register operand, or be treated as an opcode extension and not used to encode any instruction operand. The role of R/M field 1346 may include the following: encoding the instruction operand that references a memory address, or encoding either the destination register operand or a source register operand.

Scale, Index, Base (SIB) Byte (Byte 6)—As previously described, the scale field's 1250 content is used for memory address generation. SIB.xxx 1354 and SIB.bbb 1356—the contents of these fields have been previously referred to with regard to the register indexes Xxxx and Bbbb.

Displacement field 1262A (Bytes 7-10)—when MOD field 1342 contains 10, bytes 7-10 are the displacement field 1262A, and it works the same as the legacy 32-bit displacement (disp32) and works at byte granularity.

Displacement factor field 1262B (Byte 7)—when MOD field 1342 contains 01, byte 7 is the displacement factor field 1262B. The location of this field is that same as that of the legacy x86 instruction set 8-bit displacement (disp8), which works at byte granularity. Since disp8 is sign extended, it can only address between −128 and 127 bytes offsets; in terms of 64 byte cache lines, disp8 uses 8 bits that can be set to only four really useful values −128, −64, 0, and 64; since a greater range is often needed, disp32 is used; however, disp32 requires 4 bytes. In contrast to disp8 and disp32, the displacement factor field 1262B is a reinterpretation of disp8; when using displacement factor field 1262B, the actual displacement is determined by the content of the displacement factor field multiplied by the size of the memory operand access (N). This type of displacement is referred to as disp8*N. This reduces the average instruction length (a single byte of used for the displacement but with a much greater range). Such compressed displacement is based on the assumption that the effective displacement is multiple of the granularity of the memory access, and hence, the redundant low-order bits of the address offset do not need to be encoded. In other words, the displacement factor field 1262B substitutes the legacy x86 instruction set 8-bit displacement. Thus, the displacement factor field 1262B is encoded the same way as an x86 instruction set 8-bit displacement (so no changes in the ModRM/SIB encoding rules) with the only exception that disp8 is overloaded to disp8*N. In other words, there are no changes in the encoding rules or encoding lengths but only in the interpretation of the displacement value by hardware (which needs to scale the displacement by the size of the memory operand to obtain a byte-wise address offset).

Immediate field 1272 operates as previously described.

### Full Opcode Field

FIG. 13B is a block diagram illustrating the fields of the specific vector friendly instruction format 1300 that make up the full opcode field 1274 according to one embodiment of the invention. Specifically, the full opcode field 1274 includes the format field 1240, the base operation field 1242, and the data element width (W) field 1264. The base operation field 1242 includes the prefix encoding field 1325, the opcode map field 1315, and the real opcode field 1330.

### Register Index Field

FIG. 13C is a block diagram illustrating the fields of the specific vector friendly instruction format 1300 that make up the register index field 1244 according to one embodiment of the invention. Specifically, the register index field 1244 includes the REX field 1305, the REX′ field 1310, the MODR/M.reg field 1344, the MODR/M.r/m field 1346, the VVVV field 1320, xxx field 1354, and the bbb field 1356.

### Augmentation Operation Field

FIG. 13D is a block diagram illustrating the fields of the specific vector friendly instruction format 1300 that make up the augmentation operation field 1250 according to one embodiment of the invention. When the class (U) field 1268 contains 0, it signifies EVEX.U0 (class A 1268A); when it contains 1, it signifies EVEX.U1 (class B 1268B). When U=0 and the MOD field 1342 contains 11 (signifying a no memory access operation), the alpha field 1252 (EVEX byte 3, bit [7]-EH) is interpreted as the rs field 1252A. When the rs field 1252A contains a 1 (round 1252A.1), the beta field 1254 (EVEX byte 3, bits [6:4]-SSS) is interpreted as the round control field 1254A. The round control field 1254A includes a one bit SAE field 1256 and a two bit round operation field 1258. When the rs field 1252A contains a 0 (data transform 1252A.2), the beta field 1254 (EVEX byte 3, bits [6:4]-SSS) is interpreted as a three bit data transform field 1254B. When U=0 and the MOD field 1342 contains 00, 01, or 10 (signifying a memory access operation), the alpha field 1252 (EVEX byte 3, bit [7]-EH) is interpreted as the eviction hint (EH) field 1252B and the beta field 1254 (EVEX byte 3, bits [6:4]-SSS) is interpreted as a three bit data manipulation field 1254C.

When U=1, the alpha field 1252 (EVEX byte 3, bit [7]-EH) is interpreted as the write mask control (Z) field 1252C. When U=1 and the MOD field 1342 contains 11 (signifying a no memory access operation), part of the beta field 1254 (EVEX byte 3, bit [4]-S₀) is interpreted as the RL field 1257A; when it contains a 1 (round 1257A.1) the rest of the beta field 1254 (EVEX byte 3, bit [6-5]-S₂₋₁) is interpreted as the round operation field 1259A, while when the RL field 1257A contains a 0 (VSIZE 1257.A2) the rest of the beta field 1254 (EVEX byte 3, bit [6-5]-S₂₋₁) is interpreted as the vector length field 1259B (EVEX byte 3, bit [6-5]-L₁₋₀). When U=1 and the MOD field 1342 contains 00, 01, or 10 (signifying a memory access operation), the beta field 1254 (EVEX byte 3, bits [6:4]-SSS) is interpreted as the vector length field 1259B (EVEX byte 3, bit [6-5]-L₁₋₀) and the broadcast field 1257B (EVEX byte 3, bit [4]-B).

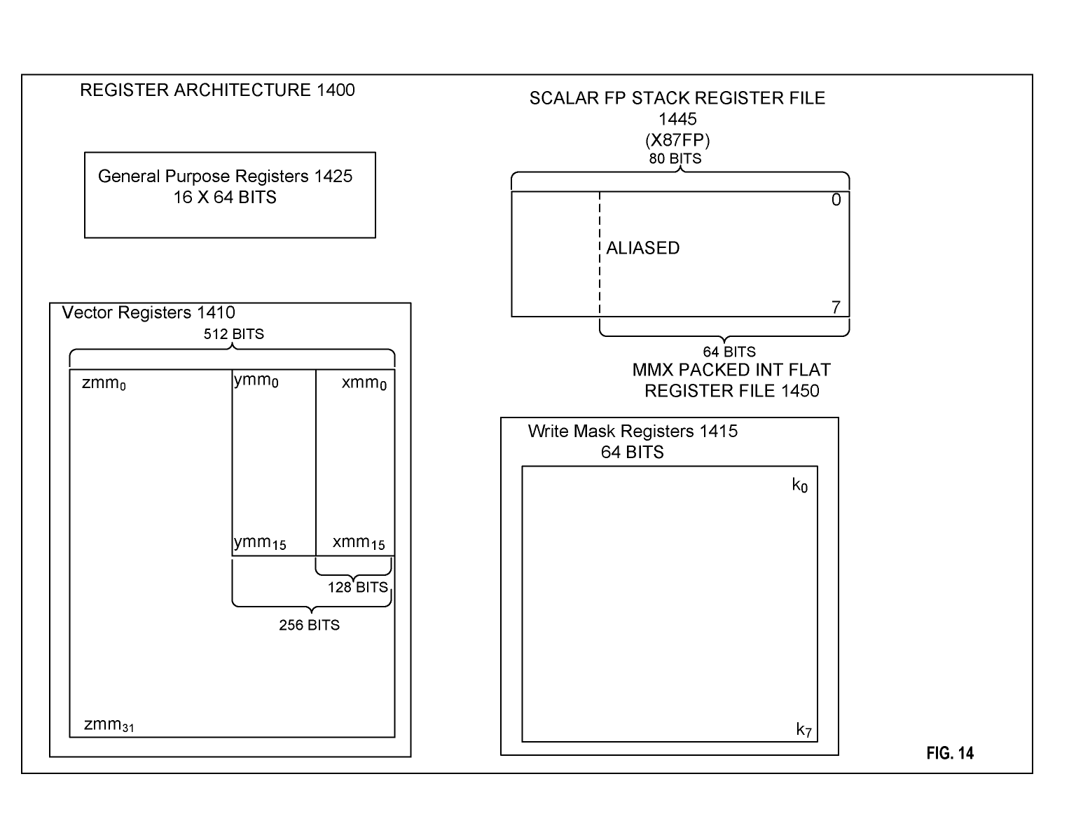

FIG. 14 is a block diagram of a register architecture 1400 according to one embodiment of the invention. In the embodiment illustrated, there are 32 vector registers 1410 that are 512 bits wide; these registers are referenced as zmm0 through zmm31. The lower order 256 bits of the lower 16 zmm registers are overlaid on registers ymm0-16. The lower order 128 bits of the lower 16 zmm registers (the lower order 128 bits of the ymm registers) are overlaid on registers xmm0-15. The specific vector friendly instruction format 1300 operates on these overlaid register file as illustrated in the below tables.

| Adjustable | | | |
|---|---|---|---|
| Vector Length | Class | Operations | Registers |
| Instruction | A (FIG. 12A; | 1210, 1215, | zmm registers |
| Templates that | U = 0) | 1225, 1230 | (the vector |
| do not include | | | length is 64 byte) |
| the vector length | B (FIG. 12B; | 1212 | zmm registers |
| field 1259B | U = 1) | | (the vector |
| | | | length is 64 byte) |
| Instruction | B (FIG. 12B; | 1217, 1227 | zmm, ymm, or |
| Templates that | U = 1) | | xmm registers |
| do include the | | | (the vector |
| vector length | | | length is 64 byte, |
| field 1259B | | | 32 byte, or 16 |
| | | | byte) depending |
| | | | on the vector |
| | | | length field 1259B |

In other words, the vector length field 1259B selects between a maximum length and one or more other shorter lengths, where each such shorter length is half the length of the preceding length; and instructions templates without the vector length field 1259B operate on the maximum vector length. Further, in one embodiment, the class B instruction templates of the specific vector friendly instruction format 1300 operate on packed or scalar single/double-precision floating point data and packed or scalar integer data. Scalar operations are operations performed on the lowest order data element position in an zmm/ymm/xmm register; the higher order data element positions are either left the same as they were prior to the instruction or zeroed depending on the embodiment.

Write mask registers 1415—in the embodiment illustrated, there are 8 write mask registers (k0 through k7), each 64 bits in size. In an alternate embodiment, the write mask registers 1415 are 16 bits in size. As previously described, in one embodiment of the invention, the vector mask register k0 cannot be used as a write mask; when the encoding that would normally indicate k0 is used for a write mask, it selects a hardwired write mask of 0xFFFF, effectively disabling write masking for that instruction.

General-purpose registers 1425—in the embodiment illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Scalar floating point stack register file (x87 stack) 1445, on which is aliased the MMX packed integer flat register file 1450—in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

Alternative embodiments of the invention may use wider or narrower registers. Additionally, alternative embodiments of the invention may use more, less, or different register files and registers.

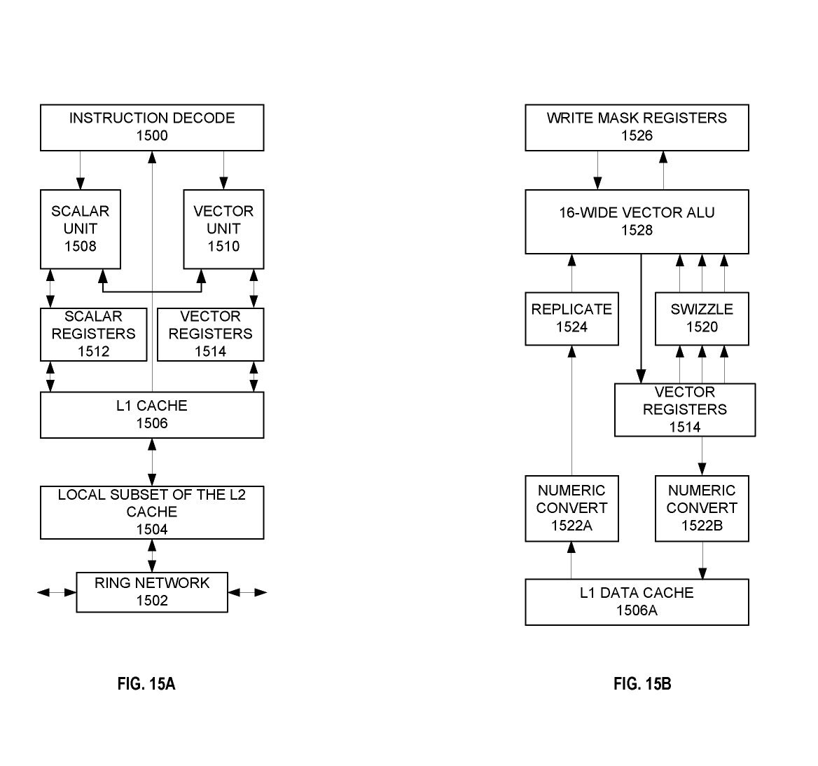

FIGS. 15A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 15A is a block diagram of a single processor core, along with its connection to the on-die interconnect network 1502 and with its local subset of the Level 2 (L2) cache 1504, according to embodiments of the invention. In one embodiment, an instruction decoder 1500 supports the x86 instruction set with a packed data instruction set extension. An L1 cache 1506 allows low-latency accesses to cache memory into the scalar and vector units. While in one embodiment (to simplify the design), a scalar unit 1508 and a vector unit 1510 use separate register sets (respectively, scalar registers 1512 and vector registers 1514) and data transferred between them is written to memory and then read back in from a level 1 (L1) cache 1506, alternative embodiments of the invention may use a different approach (e.g., use a single register set or include a communication path that allow data to be transferred between the two register files without being written and read back).

The local subset of the L2 cache 1504 is part of a global L2 cache that is divided into separate local subsets, one per processor core. Each processor core has a direct access path to its own local subset of the L2 cache 1504. Data read by a processor core is stored in its L2 cache subset 1504 and can be accessed quickly, in parallel with other processor cores accessing their own local L2 cache subsets. Data written by a processor core is stored in its own L2 cache subset 1504 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 15B is an expanded view of part of the processor core in FIG. 15A according to embodiments of the invention. FIG. 15B includes an L1 data cache 1506A part of the L1 cache 1504, as well as more detail regarding the vector unit 1510 and the vector registers 1514. Specifically, the vector unit 1510 is a 16-wide vector processing unit (VPU) (see the 16-wide ALU 1528), which executes one or more of integer, single-precision float, and double-precision float instructions. The VPU supports swizzling the register inputs with swizzle unit 1520, numeric conversion with numeric convert units 1522A-B, and replication with replication unit 1524 on the memory input. Write mask registers 1526 allow predicating resulting vector writes.

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals—such as carrier waves, infrared signals, digital signals, etc.). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware. Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

An embodiment of the invention includes a processor comprising fetch logic to fetch an instruction from memory indicating a destination packed data operand, a first source packed data operand, a second source packed data operand, and an immediate operand; and execution logic to determine a value of a first set of one or more data elements from a first specified set of bits of the immediate operand, wherein positions of the first set of one or more data elements determined from the first specified set of bits of the immediate operand are based on a first set of one or more index values that have a most significant bit corresponding to a packed data element at a first set of one or more positions of the destination packed data operand and that have a least significant bit corresponding to a data element at a corresponding position of the first source packed data operand.

An additional embodiment includes, wherein the execution logic is to further determine that the value of at least one data element is a 1; determine a value of a second set of one or more data elements (bits) from second specified set of bits of the immediate operand, wherein the positions of the second set of one or more data elements determined from the second specified set of bits of the immediate operand are based on a second set of one or more index values that have a most significant bit corresponding to a packed data element at a second set of one or more positions of the destination packed data operand and that have a least significant bit corresponding to a data element at a corresponding position of the second source packed data operand; and store the corresponding one of the second set of data elements at the second set of one or more positions of the storage location indicated by the destination packed data operand.

An additional embodiment includes, wherein the first set of positions are positions within a set of 64 packed data elements of the destination packed data operand and the first source packed data operand and the second set of positions are positions within a set of 64 packed data elements of the destination packed data operand and the second source packed data operand, and wherein the destination packed data operand, the first source packed data operand, and the second source packed data operand include a one or more sets of 64 packed data elements.

An additional embodiment includes, wherein the instruction further includes a writemask operand, and wherein the execution logic further comprises responsive to determining that the writemask operand indicates that a writemask is set for one of the set of 64 packed data elements in the destination packed data operand, and responsive to determining that a merging-masking flag is set for the instruction, preserve the values stored in the storage location indicated by the destination packed data operand for the positions indicated by the one of the set of 64 packed data elements.

An additional embodiment includes, wherein the instruction further includes a writemask operand, and wherein the execution logic, responsive to a determination that the writemask operand indicates that a writemask is set for one of the set of 64 packed data elements in the destination packed data operand, and responsive to determining that a merging-masking flag is not set for the instruction, is to further store the value 0 in the storage location indicated by the destination packed data operand for the positions indicated by the one of the set of 64 packed data elements.

An additional embodiment includes, wherein the storage location indicated by the destination packed data operand is one of a register and memory location.

An additional embodiment includes, wherein the storage location indicated by the first source packed data operand is one of a register and memory location.

An additional embodiment includes, wherein the storage location indicated by the destination packed data operand has a length of 512 packed data elements.

An embodiment of the invention includes, wherein the execution logic is to further determine that the values of all the first set of data elements are 0; and store the value 0 at the first set of one or more positions of the storage location indicated by the destination packed data operand.

An additional embodiment includes, wherein the first specified set of bits and the second specified set of bits of the immediate operand each represent the output of a binary function.

An additional embodiment includes, wherein the immediate operand has a length of 8 bits, and wherein the first specified set of bits of the immediate operand are the least significant 4 bits of the immediate operand, and wherein the second specified set of bits of the immediate operand are the most significant 4 bits of the immediate operand.

An embodiment of the invention includes a method in a computer processor, comprising fetching an instruction from memory indicating a destination packed data operand, a first source packed data operand, a second source packed data operand, and an immediate operand; and determining a value of a first set of one or more data elements from a first specified set of bits of the immediate operand, wherein positions of the first set of one or more data elements determined from the first specified set of bits of the immediate operand are based on a first set of one or more index values that have a most significant bit corresponding to a packed data element at a first set of one or more positions of the destination packed data operand and that have a least significant bit corresponding to a data element at a corresponding position of the first source packed data operand.

An additional embodiment includes, wherein the method further comprises determining that the value of at least one data element is a 1; determining a value of a second set of one or more data elements (bits) from second specified set of bits of the immediate operand, wherein the positions of the second set of one or more data elements determined from the second specified set of bits of the immediate operand are based on a second set of one or more index values that have a most significant bit corresponding to a packed data element at a second set of one or more positions of the destination packed data operand and that have a least significant bit corresponding to a data element at a corresponding position of the second source packed data operand; and storing the corresponding one of the second set of data elements at the second set of one or more positions of the storage location indicated by the destination packed data operand.

An additional embodiment includes, wherein the first set of positions are positions within a set of 64 packed data elements of the destination packed data operand and the first source packed data operand and the second set of positions are positions within a set of 64 packed data elements of the destination packed data operand and the second source packed data operand, and wherein the destination packed data operand, the first source packed data operand, and the second source packed data operand include a one or more sets of 64 packed data elements.

An additional embodiment includes, wherein the instruction further includes a writemask operand, and wherein the method further comprises responsive to determining that the writemask operand indicates that a writemask is set for one of the set of 64 packed data elements in the destination packed data operand, and responsive to determining that a merging-masking flag is set for the instruction, preserving the values stored in the storage location indicated by the destination packed data operand for the positions indicated by the one of the set of 64 packed data elements.

An additional embodiment includes, wherein the instruction further includes a writemask operand, and wherein the method further comprises, responsive to determining that the writemask operand indicates that a writemask is set for one of the set of 64 packed data elements in the destination packed data operand, and responsive to determining that a merging-masking flag is not set for the instruction, storing the value 0 in the storage location indicated by the destination packed data operand for the positions indicated by the one of the set of 64 packed data elements.

An additional embodiment includes, wherein the storage location indicated by the destination packed data operand is one of a register and memory location.

An additional embodiment includes, wherein the storage location indicated by the first source packed data operand is one of a register and memory location.

An additional embodiment includes, wherein the storage location indicated by the destination packed data operand has a length of 512 packed data elements.

An embodiment of the invention includes, wherein the method further comprises determining that the values of all the first set of data elements are 0; and storing the value 0 at the first set of one or more positions of the storage location indicated by the destination packed data operand.

An additional embodiment includes, wherein the first specified set of bits and the second specified set of bits of the immediate operand each represent the output of a binary function.

An additional embodiment includes, wherein the immediate operand has a length of 8 bits, and wherein the first specified set of bits of the immediate operand are the least significant 4 bits of the immediate operand, and wherein the second specified set of bits of the immediate operand are the most significant 4 bits of the immediate operand.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

We claim:

1. A processor comprising:
fetch logic to fetch an instruction from memory indicating a destination packed data operand, a first source packed data operand, a second source packed data operand, and an immediate operand; and
execution logic to determine a value of a first set of one or more data elements from a first specified set of bits of the immediate operand, wherein positions of the first set of one or more data elements determined from the first specified set of bits of the immediate operand are based on a first set of one or more index values that have a most significant bit corresponding to a packed data element at a first set of one or more positions of the destination packed data operand and that have a least significant bit corresponding to a data element at a corresponding position of the first source packed data operand.

2. The processor of claim 1, wherein the execution logic is to further:
determine that the value of at least one data element is a 1;
determine a value of a second set of one or more data elements (bits) from second specified set of bits of the immediate operand, wherein the positions of the second set of one or more data elements determined from the second specified set of bits of the immediate operand are based on a second set of one or more index values that have a most significant bit corresponding to a packed data element at a second set of one or more positions of the destination packed data operand and that have a least significant bit corresponding to a data element at a corresponding position of the second source packed data operand; and
store the corresponding one of the second set of data elements at the second set of one or more positions of the storage location indicated by the destination packed data operand.

3. The processor of claim 2, wherein the first set of positions are positions within a set of 64 packed data elements of the destination packed data operand and the first source packed data operand and the second set of positions are positions within a set of 64 packed data elements of the destination packed data operand and the second source packed data operand, and wherein the destination packed data operand, the first source packed data operand, and the second source packed data operand include a one or more sets of 64 packed data elements.

4. The processor of claim 3, wherein the instruction further includes a writemask operand, and wherein the execution logic further comprises:
responsive to a determination that the writemask operand indicates that a writemask is set for one of the set of 64 packed data elements in the destination packed data operand, and responsive to determining that a merging-masking flag is set for the instruction, preserve the values stored in the storage location indicated by the destination packed data operand for the positions indicated by the one of the set of 64 packed data elements.

5. The processor of claim 3, wherein the instruction further includes a writemask operand, and wherein the execution logic, responsive to determining that the writemask operand indicates that a writemask is set for one of the set of 64 packed data elements in the destination packed data operand, and responsive to determining that a merging-masking flag is not set for the instruction, is to further store the value 0 in the storage location indicated by the destination packed data operand for the positions indicated by the one of the set of 64 packed data elements.

6. The processor of claim 3, wherein the storage location indicated by the destination packed data operand is one of a register and memory location.

7. The processor of claim 3, wherein the storage location indicated by the first source packed data operand is one of a register and memory location.

8. The processor of claim 3, wherein the storage location indicated by the destination packed data operand has a length of 512 packed data elements.

9. The processor of claim 1, wherein the execution logic is to further:
determine that the values of all the first set of data elements are 0; and
store the value 0 at the first set of one or more positions of the storage location indicated by the destination packed data operand.

10. The processor of claim 1, wherein the first specified set of bits and the second specified set of bits of the immediate operand each represent the output of a binary function.

11. The processor of claim 1, wherein the immediate operand has a length of 8 bits, and wherein the first specified set of bits of the immediate operand are the least significant 4 bits of the immediate operand, and wherein the second specified set of bits of the immediate operand are the most significant 4 bits of the immediate operand.

12. A method in a computer processor, comprising:
fetching an instruction from memory indicating a destination packed data operand, a first source packed data operand, a second source packed data operand, and an immediate operand; and
determining a value of a first set of one or more data elements from a first specified set of bits of the immediate operand, wherein positions of the first set of one or more data elements determined from the first specified set of bits of the immediate operand are based on a first set of one or more index values that have a most significant bit corresponding to a packed data element at a first set of one or more positions of the destination packed data operand and that have a least significant bit corresponding to a data element at a corresponding position of the first source packed data operand.

13. The method of claim 12, further comprising:
determining that the value of at least one data element is a 1;
determining a value of a second set of one or more data elements (bits) from second specified set of bits of the immediate operand, wherein the positions of the second set of one or more data elements determined from the second specified set of bits of the immediate operand are based on a second set of one or more index values that have a most significant bit corresponding to a packed data element at a second set of one or more positions of the destination packed data operand and that have a least significant bit corresponding to a data element at a corresponding position of the second source packed data operand; and
storing the corresponding one of the second set of data elements at the second set of one or more positions of the storage location indicated by the destination packed data operand.

14. The method of claim 13, wherein the first set of positions are positions within a set of 64 packed data elements of the destination packed data operand and the first source packed data operand and the second set of positions are positions within a set of 64 packed data elements of the destination packed data operand and the second source packed data operand, and wherein the destination packed data operand, the first source packed data operand, and the second source packed data operand include a one or more sets of 64 packed data elements.

15. The method of claim 14, wherein the instruction further includes a writemask operand, and wherein the method further comprises:
responsive to determining that the writemask operand indicates that a writemask is set for one of the set of 64 packed data elements in the destination packed data operand, and responsive to determining that a merging-masking flag is set for the instruction, preserving the values stored in the storage location indicated by the destination packed data operand for the positions indicated by the one of the set of 64 packed data elements.

16. The method of claim 14, wherein the instruction further includes a writemask operand, and wherein the method further comprises:
responsive to determining that the writemask operand indicates that a writemask is set for one of the set of 64 packed data elements in the destination packed data operand, and responsive to determining that a merging-masking flag is not set for the instruction, storing the value 0 in the storage location indicated by the destination packed data operand for the positions indicated by the one of the set of 64 packed data elements.

17. The method of claim 14, wherein the storage location indicated by the destination packed data operand is one of a register and memory location.

18. The method of claim 14, wherein the storage location indicated by the first source packed data operand is one of a register and memory location.

19. The method of claim 14, wherein the storage location indicated by the destination packed data operand has a length of 512 packed data elements.

20. The method of claim 12, further comprising:
determining that the values of all the first set of data elements are 0; and
storing the value 0 at the first set of one or more positions of the storage location indicated by the destination packed data operand.

21. The method of claim 12, wherein the first specified set of bits and the second specified set of bits of the immediate operand each represent the output of a binary function.

22. The method of claim 12, wherein the immediate operand has a length of 8 bits, and wherein the first specified set of bits of the immediate operand are the least significant 4 bits of the immediate operand, and wherein the second specified set of bits of the immediate operand are the most significant 4 bits of the immediate operand.
